(19) United States
(12) Patent Application Publication
(10) Pub. No.: US 2023/0073661 A1
(43) Pub. Date: Mar. 9, 2023

(54) ACCELERATING DATA LOAD AND COMPUTATION IN FRONTEND CONVOLUTIONAL LAYER

(71) Applicant: Intel Corporation, Santa Clara, CA (US)

(72) Inventors: Deepak Abraham Mathaikutty, Chandler, AZ (US); Arnab Raha, San Jose, CA (US); Umer Iftikhar Cheema, Hillsboro, OR (US); Raymond Jit-Hung Sung, San Francisco, CA (US)

(73) Assignee: Intel Corporation, Santa Clara, CA (US)

(21) Appl. No.: 18/055,315

(22) Filed: Nov. 14, 2022

(51) Int. Cl. G06N 3/04; G06F 17/16; G06N 3/08

(52) U.S. Cl. CPC G06N 3/04; G06F 17/16; G06N 3/08

(57) ABSTRACT

An DNN (deep neural network) accelerator may accelerate deep learning, such as convolutions in frontend layers through a scheduler for loading data to be processed. The DNN accelerator may store, in a memory, an input tensor of a convolutional layer in a DNN. The convolutional layer may be the first layer or a layer that is arranged before the one or more other convolutional layers in the DNN such that data processed by the first layer can be efficiently reused across data load rounds. The input tensor includes one or more channels. A channel includes activations arranged in rows and columns. The DNN accelerator may read at least a portion of the input tensor from the memory into a datastore. The datastore includes some databanks. The DNN accelerator may provide a vector of one or more activations to a processing element for operations such as multiplications on the vector.

### TECHNICAL FIELD

This disclosure relates generally to neural networks, and more specifically, accelerating data load and computation in frontend convolutional layers of deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a compute block, in accordance with various embodiments.

FIG. 4 illustrates a data layout in a memory for a frontend convolutional layer, in accordance with various embodiments.

FIG. 5 illustrates data fetching from the memory in FIG. 4 to a datastore, in accordance with various embodiments.

FIG. 6 illustrates a layout in a datastore, in accordance with various embodiments.

FIG. 7 illustrates a round of data load from a datastore into a processing element (PE) column for a frontend convolutional layer, in accordance with various embodiments.

FIG. 8 illustrates another of round data load from the datastore into the PE column in FIG. 7, in accordance with various embodiments.

FIG. 9 illustrates data loaded to PE columns, in accordance with various embodiments.

FIG. 10 illustrates multiplication operations by a PE (processing element) for a MAC round of a frontend convolutional layer, in accordance with various embodiments.

FIG. 11 illustrates multiplication operations by another PE for the MAC round in FIG. 10, in accordance with various embodiments.

FIG. 12 illustrates reuse of activations across multiple strides along X dimension, in accordance with various embodiments.

FIG. 13 illustrates reuse of activations across multiple strides along Y dimension, in accordance with various embodiments.

FIGS. 14A and 14B illustrates activation padding, in accordance with various embodiments.

FIG. 15 illustrates data reading from a datastore for a padded tensor, in accordance with various embodiments.

FIGS. 16A-16C illustrates loading data into a PE array through the padding module, in accordance with various embodiments.

FIG. 17 is a flowchart showing a method of accelerating deep learning, in accordance with various embodiments.

FIG. 18 is a block diagram of an example DNN accelerator, in accordance with various embodiments.

FIG. 19 illustrates a PE array, in accordance with various embodiments.

FIG. 20 is a block diagram of a PE, in accordance with various embodiments.

FIG. 21 illustrates a deep learning environment, in accordance with various embodiments.

FIG. 22 is a block diagram of an example DNN system, in accordance with various embodiments.

FIG. 23 is a block diagram of an example computing device, in accordance with various embodiments.

### DETAILED DESCRIPTION

Overview

The last decade has witnessed a rapid rise in AI (artificial intelligence) based data processing, particularly based on DNN. DNNs are widely used in the domains of computer vision, speech recognition, image, and video processing mainly due to their ability to achieve beyond human-level accuracy. DNNs The significant improvements in DNN model size and accuracy coupled with the rapid increase in computing power of execution platforms have led to the adoption of DNN applications even within resource constrained mobile and edge devices that have limited energy availability.

For instance, convolutional neural networks (CNNs) have become highly influential in the field of computer vision and image processing. However, the complex nature of the CNN architectures (e.g., billions of parameters) makes it difficult to deploy them in real time. CNNs usually include convolution layers, pooling layers, activation operations, and fully connected layers. The first convolutional layer of a CNN may hold the raw pixel values of the input and extract features (color, edge, gradient orientation, etc.) from it.

Many DNN accelerators are built to accelerate convolution layers through input channel (IC) accumulation. Furthermore, they can take advantage of sparsity, where a subset of these input channels for a given (X,Y) context of a tensor is zero and by skipping the computation for these inputs, thereby improving performance and reducing overall data movement through efficient data orchestration. However, the first layer (or even one or more of the subsequent layers) is typically a dense layer and has a very small number of input channels. In many CNNs, the first layer has three input channels, such as channels corresponding to the red, green, and blue colors in the image pixels. Since these DNN accelerators are built as an IC machine, they assume a minimum number (e.g., 16 or more) of ICs that they store and operate on at a given data load and computation round. As the first layer (or even one or more of the subsequent layers) can have a much smaller number of channels, these DNN accelerators usually pad the input to the layer to at least the minimum number of ICs with zeros to reuse the same data load and computation path of the DNN accelerator. However, this approach can result in poor acceleration of the first layer (or even one or more of the subsequent layers), and it can become the bottleneck for the entire DNN and pull down the network-level performance. Therefore, improved technology for accelerating the first layer (or even one or more of the subsequent layers) is needed.

Embodiments of the disclosure provide DNN accelerators that can accelerate data load and computation in frontend layers of DNNs. A frontend layer of a DNN may be the first layer in the DNN. Alternatively, a frontend layer may be the second, third, or another layer in the DNN. The DNN may also include one or more backend layers, i.e., one or more layers that are arranged after the frontend layer(s) in the DNN. A frontend layer may include less ICs but more activations in each IC than a backend layer.

An example DNN accelerator includes a compute block that runs deep learning operations (e.g., convolution, pooling, elementwise operation, linear operation, nonlinear operation, etc.) in a DNN. The compute block can facilitate acceleration of convolutions in the DNN, such as convolutions in frontend convolutional layers and backend convolutional layers. The compute block includes a local memory, a write module, a read module, a datastore, a padding module, and a PE array. Some or all of the components in the compute block may be implemented on a chip.

In some embodiments, the local memory stores an input tensor of a convolution for a frontend layer. The input tensor can be loaded into the PE array through some or all of the write module, padding module, and read module for the PE array to perform MAC operations in the convolution. The input tensor includes one or more ICs. The number of ICs in the input tensor may be smaller than the number of ICs in the input tensor of a backend layer. An IC in the input tensor includes an array of activations, where the activations are arranged in rows and columns. A length of the rows (i.e., the number of activations in a row) is a width of the input tensor, a length of the columns (i.e., the number of activations in a column) is a height of the input tensor, and the number of ICs is a depth of the input tensor. An activation may be identified based on a (X, Y, Z) coordinate, where X indicates a position of the activation along the width of the input tensor, Y indicates a position of the activation along the height, and Z indicates a position of the activation along the depth. The activations may be stored in a X-major layout in the local memory. For instance, the local memory includes a plurality of memory banks that store different portions of the input tensor. An individual memory bank stores a group of activations that have different X coordinates but have the same Z coordinate (i.e., the same channel). In some embodiments, the group of activations in the memory bank may have the same Y coordinate.

The write module may include one or more writers that write activations in the input tensor of the frontend layer into the datastore. The datastore stores the activations in a X-major layout. The datastore may include databanks. A databank stores a sequence of activations from the same channel. The sequence of activations may have the same Y coordinate, i.e., in the same column of the input tensors. The X-major layout may facilitate more efficient data load and computation in the frontend layer given the relatively small depth but relatively large width or height of the input tensor. The datastore may also store a fixed sparsity bitmap that is generated based on a size of the kernel (e.g., the number of weights in a row or column of the kernel) of the convolution. The fixed sparsity bitmap includes a sequence of bits that have values of one and zero. The number of one valued bits in the fixed sparsity bitmap may equal the size of the kernel. The write module may write activations from the datastore into the PE array (e.g., into registered files inside the PE array). The write module may also include one or more other writer that can write activations of a backend layer into the datastore or a different datastore. A write for a backend layer may transpose data from the memory, e.g., from a X-major layout into a Z-major (or IC-major) layout. The Z-major layout may facilitate more efficient data load and computation in the backend layer given the relatively large depth but relatively small width or height of the input tensor.

The read module reads data from the datastore into storage units (e.g., register files) of the PE array. The read module may include one or more readers that read activations of a frontend layer (frontend readers) and one or more readers that read activations of a backend layer (backend readers). In some embodiments, a frontend reader may read a sequence of activations in the same channel and a fixed sparsity bitmap into the storage of the PE array. In contrast, a backend reader may read a sequence of activations that have the same (X, Y) coordinates but in different channels and a sparsity bitmap that indicates sparsity in the sequence of activations. The number of activations in the sequence read by the frontend reader may be greater than the size of the kernel. The fixed sparsity bitmap may be applied on the sequence of activations to generate an activation vector that a PE may compute. As the number of activations in the sequence is greater than the size of the kernel, a single data load round (i.e., the round of loading the sequence of activations into the PE array) may load data that can be used in multiple operation rounds of a PE. The data loaded in one loading round may be reused in the operation rounds of the PE. In embodiments where the PE includes multiple multipliers, the data can be used by different multipliers in different rounds. For the next data load round, the frontend reader may send a new read request to the datastore and the read request may include an increment size determined based on the stride size of the convolution. The increment size may be used to adjust the read pointer for the new data load round. For instance, the read pointer may be moved by the increment size so that the first activation to read in the new data load round has a distance equal to the increment size from the first activation read in the previous data load round. The increment size may equal the stride size.

In embodiments where padding is done to an input tensor of a frontend layer, the padding module may facilitate adding pad elements into a sequence of activation read from the datastore before the activations are fed into the PE array. The pad elements may have the same value, which may be a predetermined value, such as zero or a non-zero value. The padding module may determine positions where to add the pad elements based on a pad count. The padding module may also modify the increment size in the read request based on a determination that at least one pad element needs to be added to the sequence of activations, e.g., the padding module may set the increment size to zero. Based on a determination that no pad element needs to be added to the sequence of activations, the padding module may determine not to modify the increment size so that the increment size equals the stride size of the convolution.

The disclosure can improve the performance of frontend layers in DNNs by employing an optimal schedule based on the spatial dimension to load data and increasing data reuse within data computation rounds. Furthermore, the disclosure allows input data for frontend layers to be stored in the spatial dimension through multiple storage structures in the DNN accelerator, which can reduce power and perform efficient data orchestration by maximizing data reuse.

Compared to many currently available DNN accelerators that process a first DNN layer by increasing the number of input channels through padding and resulting in idle compute cycles, this disclosure can improve utilization of the datastore and the storage inside the PE array given the switching to data movement in the spatial dimension as opposed to the IC dimension. Also, data load bandwidth requirement can be reduced, and thereby improve performance of the layer. Furthermore, due to efficient data reuse across data load rounds, the overall power consumption of the DNN accelerator can be reduced. The disclose also take advantage of the sparsity mechanism that can accelerate backend layers to accelerate frontend layers by using the fixed sparsity bitmap.

For purposes of explanation, specific numbers, materials and configurations are set forth in order to provide a thorough understanding of the illustrative implementations. However, it will be apparent to one skilled in the art that the disclosure may be practiced without the specific details or/and that the disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

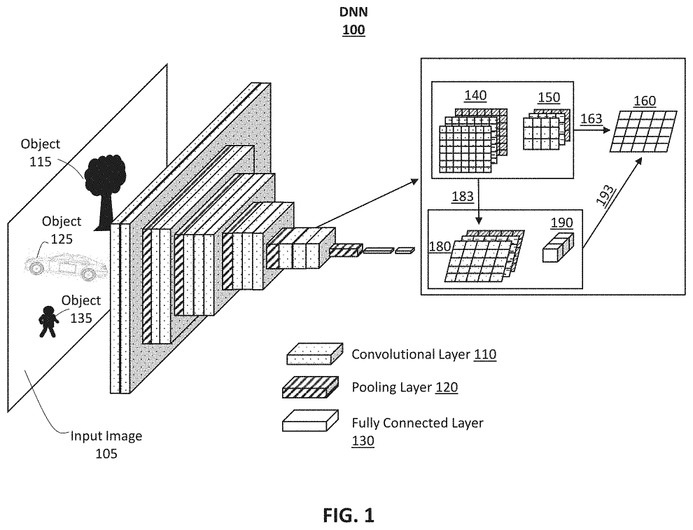

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

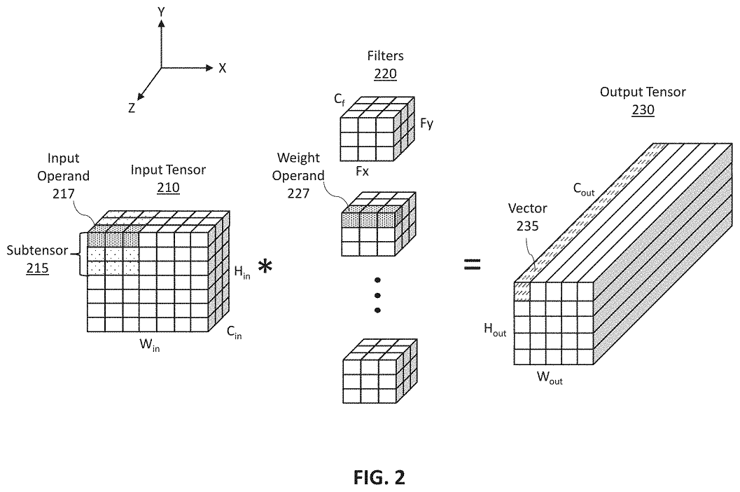

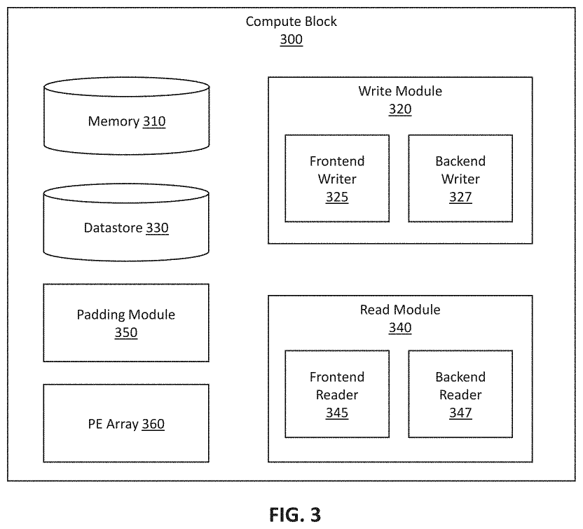

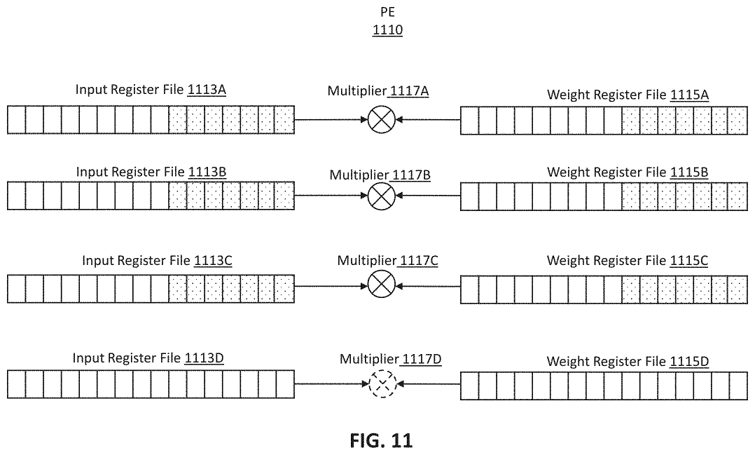

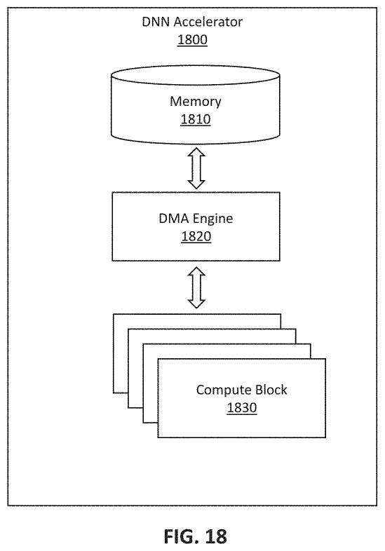

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 1800 in FIG. 18. Examples of the compute blocks may be the compute block 300 in FIG. 3 or compute blocks 1130 in FIG. 11.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤᵣ×W_{ow}×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Gₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

In some embodiments, the MAC operations on a 3×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (Y, Z) coordinate but different X coordinates. The weight operand 227 includes a sequence of weights having the same (Y, Z) coordinate but different X coordinates. The length of the input operand 217 is the same as the length of the weight operand 227. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227.

Example Compute Block

FIG. 3 is a block diagram of a compute block 300, in accordance with various embodiments. The compute block 300 computes data to run deep learning operations, such as convolution, pooling operation, elementwise operation, and so on. The compute block 300 may run a DNN layer (e.g., a frontend layer), or a portion of the DNN layer. In some embodiments, the compute block 300 may operate in parallel with one or more other compute blocks for running a convolution. The compute block 300 may be a compute block in a DNN accelerator, e.g., the DNN accelerator 1100. As shown in FIG. 3, the compute block 300 includes a memory 310, a read module 320, an datastore 330, a padding module 340, a write module 350, and a PE array 360. In other embodiments, alternative configurations, different or additional components may be included in the compute block 300. For instance, the compute block 300 may include more than one memory 310 or datastore 330. Also, the compute block 300 may include more than one read module 320, padding module 340, or write module 350. Further, functionality attributed to a component of the compute block 300 may be accomplished by a different component included in the compute block 300 or by a different system.

The memory 310 is local to the compute block 300. In the embodiments of FIG. 3, the memory 310 is inside the compute block 300. In other embodiments, the memory 310 may be outside the compute block 300. The memory 310 and the compute block 300 can be implemented on the same chip. The memory 310 stores data used for or generated from convolutions, e.g., input activations, weights, and output activations. In some embodiments, the memory 310 includes one or more SRAMs (static random-access memories). The memory 310 may be byte-addressable, and each memory address identifies a single byte (eight bits) of storage. In some embodiments, the memory 310 may includes banks, each bank may have a capacity of a fixed number of bytes, such as 32, 64, and so on.

The memory 310 may store input tensors of convolutions to be run by the PE array 360. In an embodiment, an input tensor of a convolution (e.g., a convolution of a frontend layer) may have a X-major layout in the memory 310. For instance, the X-major layout starts with activations having different X coordinates but the same Y and Z coordinates. The activations having (Y,Z)=(0,0) are followed by activations having (Y,Z)=(1,0), further followed activations having (Y,Z)=(2,0), and so on. All the activations having Z=0 are followed by activations having Z=1, till all the activations in the input tensor are stored.

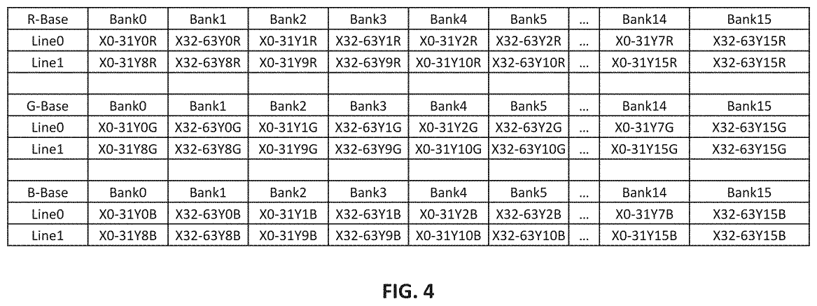

In another embodiment, an input tensor of a convolution (e.g., a convolution of a backend layer) may have a Z-major (i.e., IC-major) layout in the memory 310. For instance, the Z-major layout starts with activations having different Z coordinates but the same X and Y coordinates. The activations having (X,Y)=(0,0) are followed by activations having (X,Y)=(1,0), further followed activations having (X,Y)=(2,0), till all the activations in the input tensor are stored. Certain aspects of the memory 310 are described below in conjunction with FIG. 4.

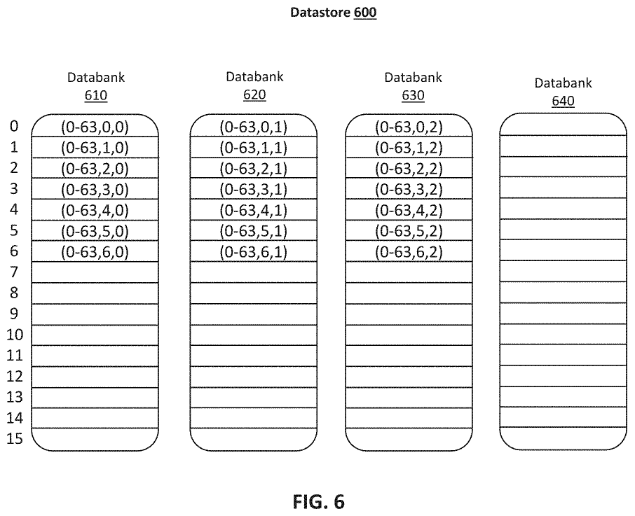

The write module 320 write data from the memory 310 into the datastore 330. The datastore 330 stores activations read from the memory 310. The datastore 330 may function as a buffer between the memory 310 and the PE array 360. In some embodiments, the datastore 330 may store a portion of an input tensor at a time. In some embodiments, the datastore 330 includes databanks. A databank may store activations in the same channel, i.e., activations having the same Z coordinate. The databank may include a sequence of storage units. A storage unit may store a portion of the activations in the databank. The activations in the same storage unit may have the same Y coordinate. In some embodiments, the storage units may have a fixed storage size, e.g., 32, 64, 126 bytes. The number of storage units in the datastore 330 may be 8, 16, 32, 64, and so on. Certain aspects of the datastore 330 are described below in conjunction with FIG. 6.

The datastore 330 may store activations for a frontend layer with a X-major layout. The X-major layout may facilitate more efficient data load and computation in the frontend layer given the relatively small depth but relatively large width or height of the input tensor. The datastore 330 may also store a fixed sparsity bitmap that is generated based on a size of the kernel (e.g., the number of weights in a row or column of the kernel) of the convolution. The fixed sparsity bitmap includes a sequence of bits that have values one and zero. The number of one valued bits in the fixed sparsity bitmap may equal the size of the kernel.

The datastore 330 may store activations for a backend layer with a Z-major layout. The Z-major layout may facilitate more efficient data load and computation in the backend layer given the relatively large depth but relatively small width or height of the input tensor. The datastore 330 may also store one or more sparsity bitmaps of the activations. A sparsity bitmap may correspond to a sequence of activation (e.g., a sequence of activation to be loaded into the PE array in a data load round). The sparsity bitmap includes a sequence of bits, each of which correspond to a different activation in the sequence of activation. The value of a bit indicates whether the value of the corresponding activation is zero or non-zero. For instance, a zero valued bit indicates that the value of the corresponding activation is zero, versus a non-zero valued bit indicates that the value of the corresponding activation is non-zero. The position of a bit in the sparsity bitmap may match the position of the corresponding activation in the sequence of activation. The number of bits in the sparsity bitmap may equal the number of activations in the sequence of activation. The sparsity bitmap may be used for accelerating MAC operations by the PE array 360, e.g., through a sparsity logic, as the PE array 360 may omit MAC operations on zero valued activations.

The write module 320 may load a whole input tensor into the datastore 330 through multiple data transfer rounds, each of which transfers a portion of the input tensor into the datastore 330. In the embodiments of FIG. 3, the write module 320 includes a frontend writer 325 and a backend writer 327. In other embodiments, the write module 320 may include fewer, more, or different components. For instance, the write module 320 may include more than one frontend writer 325 or backend writer 327.

The frontend writer 325 writes activations in input tensors of frontend layers into the datastore 330. In embodiments where the memory 310 stores activations in a X-major layout, the frontend writer 325 may write the activations into the datastore 330 without transposing the activations. In where the memory 310 stores activations in other layouts (e.g., Y-major layout or Z-major layout), the frontend writer 325 may transpose the activations to convert it to a X-major layout before writing the activations into the datastore 330.

The backend writer 327 writes activations in input tensors of backend layers into the datastore 330. In embodiments where the memory 310 stores activations in a Z-major layout, the backend writer 327 may write the activations into the datastore 330 without transposing the activations. In where the memory 310 stores activations in other layouts (e.g., X-major layout or Y-major layout), the backend writer 327 may transpose the activations to convert it to a Z-major layout before writing the activations into the datastore 330.

The read module 340 reads data from the datastore 330 into internal storage (e.g., register files) of the PE array 360. In the embodiments of FIG. 3, the read module 340 includes a frontend reader 345 and a backend reader 347. In other embodiments, the read module 340 may include fewer, more, or different components. For instance, the write module 320 may include more than one frontend reader 345 or backend reader 347.

The frontend reader 345 reads activations from the datastore 330 into the internal storage of the PE array 360 for a frontend layer. In some embodiments, the frontend reader 345 perform multiple data load rounds for a convolution. In a data load round, the frontend reader 345 may read a sequence of activations and a fixed sparsity bitmap into the internal storage of the PE array 360. The sequence of activations is in the same channel and may even have the same Y coordinate. The number of activations in the sequence may be determined on a storage size of a storage structure in the PE array 360, e.g., a register file. In some embodiments, the number of activations in the sequence may be 8 bytes, 16 bytes, 32 bytes, and so on.

The number of activations in the sequence read by the frontend reader 345 may be greater than the size of the kernel of the convolution. The fixed sparsity bitmap may be applied on the sequence of activations to generate an activation vector that a PE in the PE array 360 may compute. As the number of activations in the sequence is greater than the size of the kernel, a single data load round (i.e., the round of loading the sequence of activations into the PE array) may load data that can be used in multiple operation rounds of a PE. The data loaded in one loading round may be reused in the operation rounds of the PE. In embodiments where the PE includes multiple multipliers, the data can be used by different multipliers in different rounds.

For the next data load round, the frontend reader 345 may send a new read request to the datastore 330 and the read request may include an increment size determined based on the stride size of the convolution. The increment size may be used to adjust the read pointer for the new data load round. For instance, the read pointer may be moved by the increment size so that the first activation to read in the new data load round has a distance equal to the increment size from the first activation read in the previous data load round. The increment size may equal the stride size.

The backend reader 347 reads activations from the datastore 330 into the internal storage of the PE array 360 for a backend layer. The backend reader 347 may read a sequence of activations that have the same (X, Y) coordinates but in different channels and a sparsity bitmap that indicates sparsity in the sequence of activations. The PE array 360 may use the sparsity bitmap to accelerate the computation of the activations.

The padding module 350 facilitates activation padding to generate an input tensor that includes activations from the datastore 330 (or the memory 310) and pad elements. For instance, in embodiments where padding is needed, the padding module 350 may facilitate adding pad elements into a sequence of activations read from the datastore 330 before the activations are fed into the PE array 360. The pad elements may have the same value, which may be a predetermined value, such as zero or a non-zero value.

The padding module 350 may determine positions where to add the pad elements based on a pad count. The pad count may indicate the number of rows or columns to be added to a channel of the input tensor. Pad elements may be added to one or more edges of the input tensor. For instance, a pad count of 1 may indicates that one row is to be added to the top of the input tensor, one row is to be added to the bottom of the input tensor, one column is to be added to the right of the input tensor, one column is to be added to the left of the input tensor, or some combination thereof. In some embodiments, there may be multiple pad count that indicates the number of pad elements to be added to different edges of the input tensor.

The padding module 350 may subtract a pad count from the (X,Y) coordinate of a position in the input tensor to determine whether the position is a pad position, i.e., whether the coordinate is a pad coordinate. In an example, the padding module 350 may determine that a position in the input tensor is a pad position based on a determination that a result of subtracting a left pad count (i.e., the number of column(s) of pad elements to be added to the left of the original tensor) from the X coordinate of the position is smaller than the left pad count. In another example, the padding module 350 may determine that a position in the input tensor is a pad position based on a determination that a result of subtracting a right pad count (i.e., the number of column(s) of pad elements to be added to the right of the original tensor) from the X coordinate of the position is larger than the width of the original tensor, which may be the greatest X coordinate in the original tensor). In yet another example, the padding module 350 may determine that a position in the input tensor is a pad position based on a determination that a result of subtracting a top pad count (i.e., the number of row(s) of pad elements to the top of the original tensor) from the Y coordinate of the position is smaller than the top pad count. In yet another example, the padding module 350 may determine that a position in the input tensor is a pad position based on a determination that a result of subtracting a bottom pad count (i.e., the number of row(s) of pad elements to the bottom of the original tensor) from the Y coordinate of the position is greater than the height of the original tensor, which may be the greatest Y coordinate in the original tensor.

In response to determining that the position is a pad position, the padding module 350 may place a pad element at the position. In some embodiments, pad elements are not stored in the datastore 330, or one pad element (as opposed to all the pad elements) may be stored in the datastore 330. The padding module 350 can place pad elements at pad positions in the input tensor and place activations read from the datastore 330 at other positions in the input tensor.

The padding module 350 may modify a read request from the read module 340 (e.g., the frontend reader 345) or generate a new read request to read activations from the datastore 330. Due to the addition of pad elements, multiple data load rounds may need the same position of the read pointer as the first activation to be read from the datastore 330 are the same. The padding module 350 may determine whether a sequence of activations to be loaded to the PE array 360 includes at least one pad element. In response to determining that the sequence of activations includes at least one pad element, the padding module 350 may set the increment size to zero so that the position of the read pointer will not be changed from the last read. The padding module 350 may modify the increment size in the read request from the read module 340 (e.g., the frontend reader 345) from the stride size to zero. Alternatively, the padding module 350 may generate the read request with a zero valued increment size. In response to determining that the sequence of activations includes no pad element, the padding module 350 may set the increment size to the stride size or make no modification to the increment size determined by the read module 340 (e.g., the frontend reader 345). The number of data load rounds where the increment size is zero may equal a pad count.

The PE array 360 performs MAC operations in convolutions. The PE array 360 may perform other deep learning operations. The PE array 360 may include PEs arranged in columns, or columns and rows. Each PE can perform MAC operations. In some embodiments, a PE includes one or more multipliers for performing multiplications. An PE may also include one or more adders for performing accumulations. A column of PEs is referred to as a PE column. A PE column may be associated with one or more MAC lanes. A MAC lane is a path for loading data into a MAC column. A MAC lane may be also referred to as a data transmission lane or data load lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 360 may be capable of depthwise convolution, standard convolution, or both. In a depthwise convolution, a PE may perform an MAC operation that include a sequence of multiplications for an input operand (e.g., the input operand 217) and a weight operand (e.g., the weight operand 227). Each multiplication in the sequence is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 360 may output multiple output operands at a time, each of which is generated by a different PE. In a standard convolution, MAC operations may include accumulations across the channels. For instance, as opposed to generating an output operand, a PE may accumulate products across different channels to generate a single output point.

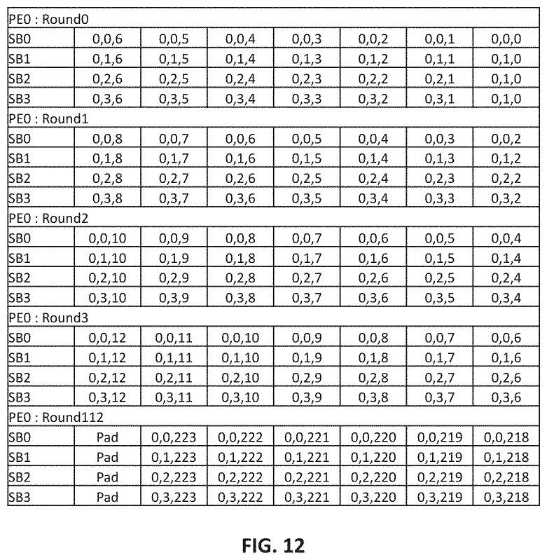

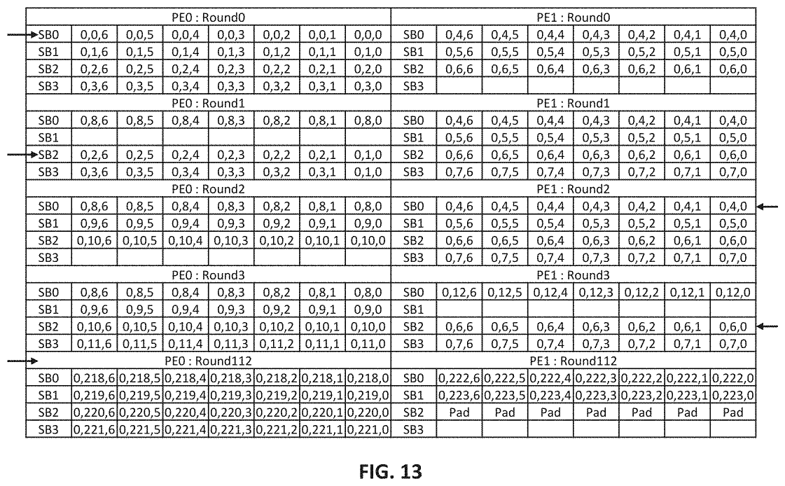

A PE may perform multiple rounds of MAC operations for a convolution. Data (activations, weights, or both) may be reused within a single round, e.g., across different multipliers in the PE, or reused across different rounds of MAC operations. The data reuse may be facilitated by the X-major layout of activation data and the data load by the read module 340. More details regarding data reuse are described below in conjunction with FIGS. 12 and 13. More details regarding PE array are described below in conjunction with FIGS. 11, 19, and 20.

Example Data Layout in Local Memory

FIG. 4 illustrates a data layout in a memory for a frontend convolutional layer of a DNN, in accordance with various embodiments. The memory may be the memory 310 in FIG. 3. The data layout includes activations in an input tensor of the frontend convolutional layer. The frontend convolutional layer is the first convolutional layer in a DNN (e.g., the DNN 100 in FIG. 1) in the embodiments of FIG. 4. In other embodiments, the frontend convolutional layer may be a layer arranged after the first convolutional layer but is arranged relatively in the front of the DNN. An example of the input tensor is an image input into the DNN. For the purpose of illustration, the input tensor includes three channels: R, G, and B, which represents red, green, and blue respectively. Each channel includes activations arranged in a 64×16 array, i.e., there are 64 activations in each row and 16 activations in each column. In some embodiments, the activations in the input tensor are dense data. For instance, the activations may all have non-zero values.

In FIG. 4, each channel has a separate base address: R-base, G-base, and B-base. The base addresses may be programed into the write module (e.g., the write module 320) that can write the data in the memory into a datastore. With the base addressed programed into the write module, the write module may become aware of the X-major layout for fetching data from the memory and for populating entries into the datastore. Each base address has two lines (Line0 and Line1). Each line includes 15 banks: Bank0-Bank 15. Each bank stores 32 activations. An activation may take a byte. The storage size of each bank may be 32 bytes. In other embodiments, the memory may include a different number of banks. A bank may have a different storage size or may store a different number of activations. The data layout in FIG. 4 is a X-major layout. As shown in FIG. 4, Bank0 of Line0 stores the first 32 activations in the first row in the R channel, and Bank1 of Line0 stores the other 32 activations in the first row in the R channel. Bank1 is followed by Bank2 and Bank3 that store the 64 activations in the second row in the R channel. This pattern continues till Bank14 and Bank15 that store the 64 activations in the sixteenth row in the R channel. The storage patterns of the activations in the G channel and the B channel are similar.

The memory may have a different data layout for a backend layer. For instance, activations of a backend layer may be stored with a Z-major layout. In an example Z-major layout of an input tensor, the activations in the first row and the first columns in all the channels are stored first, followed by the activations in the second row and the first column in all the channels, till all the activations are stored.

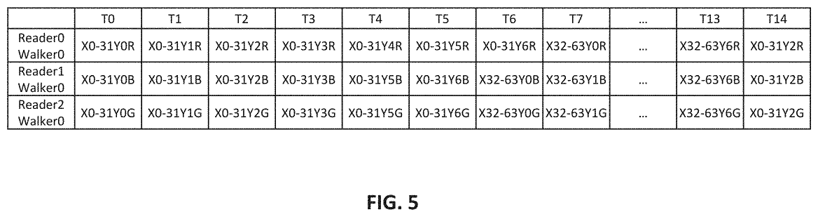

FIG. 5 illustrates data transfer from the memory in FIG. 4 to a datastore, in accordance with various embodiments. An example of the datastore is the datastore 330 in FIG. 3. The data transfer is done by three readers, Reader0-2, and a writer, Writer0. Reader0-2 may be readers in the read module 320. Writer( ) may be a writer in the write module 340. The data transfer includes a sequence of rounds. For the purpose of illustration, FIG. 5 shows 15 rounds: T0-T14. There may be additional rounds in the data transfer that are now shown in FIG. 5.

In the embodiments of FIG. 5, each channel has a different reader. Reader( ) reads activations in the red channel from the memory, Reader1 reads activations in the blue channel from the memory, and Reader2 reads activations in the green channel from the memory. One writer writes all the activations into the datastore. In other embodiments, there can be a different number of readers or writers for the data transfer.

As shown in FIG. 5, each round includes the transfer of a sequence of activations. The activations in the same sequence are in the same channel and has the same Y coordinate. For instance, T0 by each reader is for transferring 32 activations in the first row in the corresponding channel, T1 is for transferring the other 32 activations in the first row in the channel. The convolution in FIG. 5 has a kernel having a size of 7×7. Reader( ) transfer 32 activations in each of the first seven rows (Y0-Y6) in T0-T6. T7-T13 is for transferring the other 32 activations in each of the first seven rows (Y0-Y6). T14 is the first round to transfer activation in the second row.

Example Layout in Datastore

FIG. 6 illustrates a layout of a datastore 600, in accordance with various embodiments. The datastore 600 may be an embodiment of the datastore 240 in FIG. 2. As shown in FIG. 6, the datastore 600 includes four databanks 610, 620, 630, and 640. Each databank includes 16 storage units. In other embodiments, the datastore 600 may include a different number of databanks, and a databank may include a different number of storage units.

A databank may store contexts for a PE column to perform MAC operations. In an example, for a single databank, the number of storage units that store contexts for a convolution operation round may equal to the number of PEs that perform MAC operations in the corresponding PE column. The contexts may be retrieved by a read module (e.g., the read module 340) in an order, e.g., the order the storage units are arranged in the databank. For instance, the read module reads a single storage unit at a time. The read module may load the storage unit to a PE before it reads the next storage unit.

A storage unit may be accessed individually. In some embodiments, a storage unit stores a single context at a time. The storage unit may also store a sparsity bitmap for the context so that the reading module accessing the storage unit can perform sparsity decoding and sparsity alignment before the reading module transfers the context to a PE. In other embodiments, a storage unit may store a portion of a context or multiple contexts. In embodiments where a storage unit stores a portion of a context, the storage unit may store a sparsity bitmap for the whole context. Alternatively, the storage unit does not store the sparsity bitmap and the sparsity bitmap is stored in another storage unit that stores another portion of the context. In embodiments where a storage unit stores multiple contexts, the storage unit may store the sparsity bitmap for all the contexts. A storage unit may be a buffer, such as a circular buffer. A storage unit has a storage limit, but different storage units may have the same or different storage limits.

As shown in FIG. 6, the datastore 600 stores a portion of an input tensor having three channels with a X-major layout. The databank 610 stores activations in the first channel, the databank 620 stores activations in the second channel, the databank 630 stores activations in the third channel, and the databank 640 is empty. The activations are represented by their (X, Y, Z) coordinates. The databank 610 includes seven active storage units, i.e., storage units that store data and are not empty. Each storage unit stores 64 activations in the same row of the input tensor. The databank 610 stores the first seven rows of the first channel. Similarly, the databank 620 stores the first seven rows of the second channel, and the databank 630 stores the first seven rows of the third channel. The reason for storing the first seven rows of the input tensor may be that the kernel size is 7×7. In embodiments where the kernel has a different size, the number of active storage units in a databank may be different.

As the number of channels in the input tensor is small, the X-major layout, compared with a Z-major layout can in reducing the number of storage units utilized across each databank. For each databank, seven storage units are utilized and populated with activations of distinct Y coordinates. This can allow the data distribution network to completely power down the databank 640. Furthermore, each storage unit can be fully utilized as the technique populates them with data from the X dimension, which is larger for the first layer than other layers in the DNN.

Example Data load from Datastore to PE Column

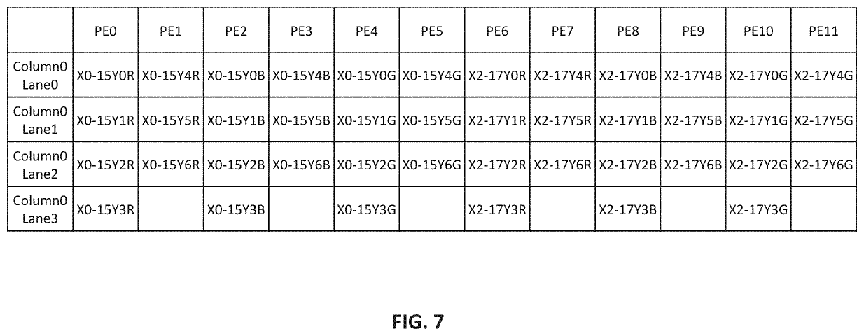

FIG. 7 illustrates a round of data load from a datastore into a PE column for a frontend convolutional layer, in accordance with various embodiments. The data load may be performed by MAC lanes. In the embodiments of FIG. 7, the data load is for loading data to a PE column represented as Column0 in FIG. 7 through four MAC lanes: Lane0-Lane3. Each MAC lane may be used for loading data for a multiplier of each PE in the column. For purpose of illustration, FIG. 7 shows 12 PEs: PE0-PE11, and each PE includes four multipliers. There may be a different number of PEs in the PE column or a different number of multipliers in a PE.

An MAC lane may load a sequence of 16 activations for a multiplier in a PE. The 16 activations have different X coordinates but the same Y and Z coordinates. The kernel size is seven, so the 16 activations may be used in multiple rounds of operations oft he multiplier, which can improve the efficiency of data load and a single data load round can facilitate multiple computation rounds. As the kernel size is seven and a PE includes four multipliers, the MAC operations on a subtensor in the input tensor and a filter may be done by two PEs, in which one multiplier may be inactive. For instance, PE0 and PE1 may perform the first rounds of MAC operations for the red channel, PE2 and PE3 may perform the first rounds of MAC operations for the blue channel, and PE4 and PE5 may perform the first rounds of MAC operations for the green channel.

Other PEs may perform other rounds of MAC operations in the convolution. For instance, PE7-PE11 performs the second round of MAC operations in the convolution. The stride size of the convolution is 2 in the embodiments of FIG. 7, so PE6 receives activations having X coordinates of X2-17. In embodiments where there are more PEs, e.g., PE12-PE16, these PEs may perform the third round of MAC operations in the convolution or even more rounds.

As the kernel size is seven, a PE needs to compute on seven activations in the X dimension. The fixed sparsity bitmap may be applied, for each channel, onto the sequence of 16 activations to generate an input operand of seven activations. In the next round, it can start to stride in the the X direction using the newly added fixed sparsity bitmap from the datastore until it reaches the end of the X coordinates (i.e., the last X coordinate in a row, e.g., X63 in the 64×16×3 input tensor) for the seven Y coordinates. After the data distribution reaches the end of the X coordinates (i.e., the last X coordinate in a row, e.g., X63 in the 64×16×3 input tensor), the X coordinate will be reset, e.g., to X0 (i.e., the first activation in a row). It will stride in the Y direction.

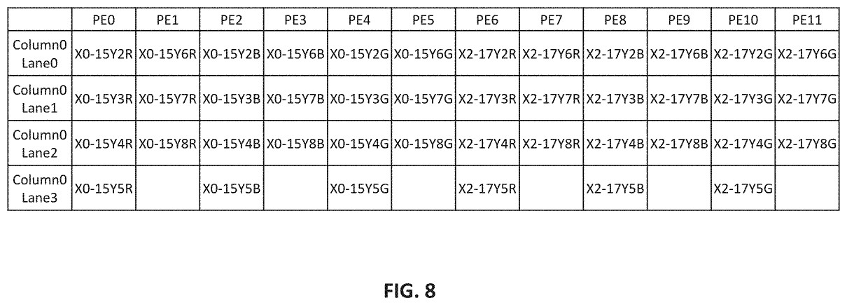

FIG. 8 illustrates another of round data load from the datastore into the PE column in FIG. 7, in accordance with various embodiments. FIG. 8 shows the round of data load after the PE column has finished rounds of MAC operations for all the activations in the first seven row, i.e., the end of the X coordinates in the input tensor has been reached. The X coordinate is reset to X0, but the Y coordinate is reset to Y2 from Y0 as the stride size is 2. After the data distribution in FIG. 8 reaches the end of the X coordinates (i.e., the last X coordinate in a row, e.g., X63 in the 64×16×3 input tensor), it will reset the X coordinate (e.g., reset to X0, i.e., the first activation in a row) and stride in the Y direction, which is illustrated in FIG. 8.

FIG. 8 shows two strides along the X direction. Even though not shown in FIG. 8, there may be more strides along the X direction till the end of the X coordinates is reached. Then, it will stride further down in the Y direction. For instance, the X coordinate will be reset to X0 again and the Y coordinate will be set to Y4.

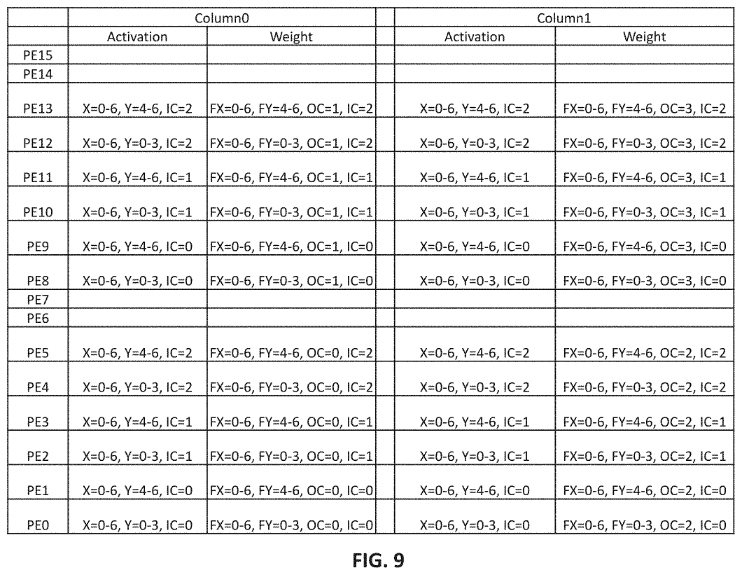

FIG. 9 illustrates data loaded to PE columns, in accordance with various embodiments. For the purpose of illustration, FIG. 9 shows two PE columns: Column0 and Column1. Each column includes 16 PEs: PE0-PE15. The two PE columns may be in a PE array, e.g., the PE array 360. In an embodiment, the input tensor of the convolution has a spatial size of 64×16×4, and the kernel has a size of 7×7. There may be one or more other PE columns in the PE array. Also, a PE column may include a different number of PEs. Different PE columns may include different number of PEs. The input tensor or kernel may have a different size.

As shown in FIG. 9, PE0 in Column0 receives four input operands and four weight operands. Each input operand includes seven activations X0-6 that have the same Y coordinate and same IC. Each weight operand includes seven weights FX0-6 that have the same Y coordinate (i.e., FY) and same IC. PE0 may include four multipliers, each of which may receive an input operand and a weight operation for a round of computation. Similarly, PE1-PE5 and PE8-PE13 each receive four input operands and four weight operands.

As shown in FIG. 9, PE0-PE5 in Column0 perform the MAC operations in the first stride of the convolution for the first output channel (OC=0), PE8-PE13 in Column0 perform the MAC operations in the first stride of the convolution for the second output channel (OC=1), PE0-PE5 in Column1 perform the MAC operations in the first stride of the convolution for the third output channel (OC=2), and PE8-PE13 in Column1 perform the MAC operations in the first stride of the convolution for the fourth output channel (OC=3). Given the kernel size and the number of PEs in each column, PE6, PE7, PE15, and PE16 don't receive any data and can be inactive. These four PEs can be gated to reduce power consumption of the PE array.

Example PE Computation

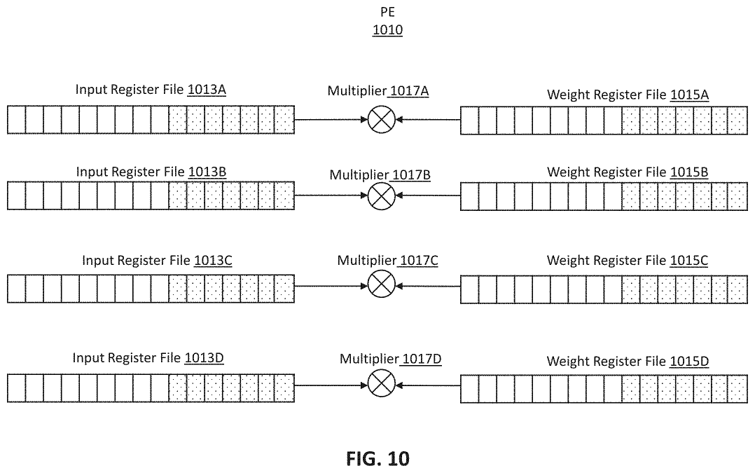

FIG. 10 illustrates multiplication operations by a PE 1010 for a MAC round of a frontend convolutional layer, in accordance with various embodiments. The PE 1010 may be an embodiment of one of the active PEs in FIG. 9, such as PE0 in Column1. The PE 1010 includes four input register files 1013A-D (collectively referred to as “input register files 1013” or “input register file 1013”), four weight register files 1015A-D (collectively referred to as “weight register files 1015” or “weight register file 1015”), and four multipliers 1017A-D (collectively referred to as “multipliers 1017” or “multiplier 1017”). Even though not shown in FIG. 10, the PE 1010 may include other components, such as an internal adder assembly, an output register file, etc. Also, the PE 1010 may include a different number of input register files or weight register files.

In the embodiments of FIG. 10, each input register file 1013 is loaded with an input operand that includes seven activations. The number of activations in the input operand may be determined based on the kernel size of the convolution. For instance, the kernel size may be 7×7. The activations in the input operand have the same Y coordinate and Z coordinate, but different X coordinates. The Y coordinates of activations in different input register files 1013 may be different. In an example, the input register file 1013A stores activations (0-6, 0, 0), the input register file 1013B stores activations (0-6, 1, 0), the input register file 1013C stores activations (0-6, 2, 0), and the input register file 1013D stores activations (0-6, 3, 0). For purpose of illustration, each input register file 1013 includes 16 bytes and the bytes of the activations are highlighted with a dot pattern in FIG. 10.

Each of the weight register files 1015 is loaded with a weight operand that includes a sequence of seven weights. The weights in the weight operand have the same Y coordinate and Z coordinate, but different X coordinates. The Y coordinates of weights in different weight register files 1015 may be different. In an example, the weight register files 1015A stores weights (0-6, 0, 0), the weight register files 1015B stores weights (0-6, 1, 0), the weight register files 1015C stores weights (0-6, 2, 0), and the weight register files 1015D stores weights (0-6, 3, 0). A weight may have a fourth coordinate that indicates the output channel. In some embodiments, the weights in a subset or all of the weight register files 1015 are in the same output channel. For purpose of illustration, each weight register files 1015 includes 16 bytes and the bytes of the weights are highlighted with a dot pattern in FIG. 10.

The activations have X-major layouts in the input register files 1013. Compared with Z-major layouts, the utilization of the input register files 1013 is better. With Z-major layouts, an input operand in an input register file 1013 would have activations having the same (X, Y) coordinates across all the channels. Since the input tensor includes three channels, the input operand would have three activations stored in the input register file 1013, resulting in a utilization of 3/16 versus a utilization of 7/16 with the X-major layout. Similarly, the utilization of the weight register files 1015 is also better with the X-major layout than the Z-major layout.

The multiplier 1017A receives the input operand from the input register file 1013A and the weight operand from the weight register file 1015A. The multiplier 1017A sequentially performs seven cycles of multiplication operations. In each cycle, the multiplier 1017A multiplies an activation and a weight and generates a product. The position of the activation in the input operand matches the position of the weight in the weight operand. The multiplier 1017A processes the activations and weights sequentially based on their positions in the input operand and weight operand. For instance, the multiplier 1017A multiples the first input element and the first weight in the first cycle, multiples the second input element and the second weight in the second cycle and continues till it finishes the multiplication of the seventh input element and the seventh weight in the seventh cycle.

Similarly, the multiplier 1017B receives the input operand from the input register file 1013B and the weight operand from the weight register file 1015B. The multiplier 1017B sequentially performs seven cycles of multiplication operations. In each cycle, the multiplier 1017B multiplies an input element and a weight and generates a product. The multiplier 1017C receives the input operand from the input register file 1013C and the weight operand from the weight register file 1015C. The multiplier 1017C sequentially performs seven cycles of multiplication operations. In each cycle, the multiplier 1017C multiplies an activation and a weight and generates a product. The multiplier 1017D receives the input operand from the input register file 1013D and the weight operand from the weight register file 1015D. The multiplier 1017D sequentially performs seven cycles of multiplication operations. In each cycle, the multiplier 1017D multiplies an activation and a weight and generates a product. The multipliers 1017A-C may operate simultaneously. In some embodiments, the cycles of multiplication operations by the multipliers may be synchronized. For instance, the multipliers 1017 perform each of the seven cycles at a same time. Since the kernel size is 7×7 but there are four multipliers 1017 in the PE 1010, another PE is needed to complete the stride.

FIG. 11 illustrates multiplication operations by another PE 1110 for the MAC round in FIG. 10, in accordance with various embodiments. The PE 1110 performs MAC operations for the portions of the MAC round that is not performed by the PE 1010. The PE 1110 may be an embodiment of one of the active PEs in FIG. 9, such as PE1 in Column1. The PE 1110 includes four input register files 1113A-D (collectively referred to as “input register files 1113” or “input register file 1113”), four weight register files 1115A-D (collectively referred to as “weight register files 1115” or “weight register file 1115”), and four multipliers 1117A-D (collectively referred to as “multipliers 1117” or “multiplier 1117”). Even though not shown in FIG. 11A, the PE 1110 may include other components, such as an internal adder assembly, an output register file, etc. Also, the PE 1110 may include a different number of input register files or weight register files.

In the embodiments of FIG. 11, each of the input register files 1113A-C is loaded with an input operand that includes seven activations. The input register file 1113D is empty. The number of activations in the input operand may be determined based on the kernel size of the convolution. For instance, the kernel size may be 7×7. The activations in the input operand have the same Y coordinate and Z coordinate, but different X coordinates. The Y coordinates of activations in different input register files 1113 may be different. In an example, the input register file 1113A stores activations (0-6, 4, 0), the input register file 1113B stores activations (0-6, 5, 0), and the input register file 1113C stores activations (0-6, 6, 0). For purpose of illustration, each input register file 1113 includes 16 bytes and the bytes of the activations are highlighted with a dot pattern in FIG. 11.

Each of the weight register files 1115A-C is loaded with a weight operand that includes a sequence of seven weights. The weight register file 1115D is empty. The weights in the weight operand have the same Y coordinate and Z coordinate, but different X coordinates. The Y coordinates of weights in different weight register files 1115 may be different. In an example, the weight register files 1115A stores weights (0-6, 0, 0), the weight register files 1115B stores weights (0-6, 1, 0), the weight register files 1115C stores weights (0-6, 2, 0), and the weight register files 1115D stores weights (0-6, 3, 0). A weight may have a fourth coordinate that indicates the output channel. In some embodiments, the weights in a subset or all of the weight register files 1115 are in the same output channel. For purpose of illustration, each weight register files 1115 includes 16 bytes and the bytes of the weights are highlighted with a dot pattern in FIG. 11.

The activations have X-major layouts in the input register files 1113. Compared with Z-major layouts, the utilization of the input register files 1113 is better. With Z-major layouts, an input operand in an input register file 1113 would have activations having the same (X, Y) coordinates across all the channels. Since the input tensor includes three channels, the input operand would have three activations stored in the input register file 1113, resulting in a utilization of 3/16 versus a utilization of 7/16 with the X-major layout. Similarly, the utilization of the weight register files 1115 is also better with the X-major layout than the Z-major layout.

The multiplier 1117A receives the input operand from the input register file 1113A and the weight operand from the weight register file 1115A. The multiplier 1117A sequentially performs seven cycles of multiplication operations. In each cycle, the multiplier 1117A multiplies an activation and a weight and generates a product. The position of the activation in the input operand matches the position of the weight in the weight operand. The multiplier 1117A processes the activations and weights sequentially based on their positions in the input operand and weight operand. For instance, the multiplier 1117A multiples the first input element and the first weight in the first cycle, multiples the second input element and the second weight in the second cycle and continues till it finishes the multiplication of the seventh input element and the seventh weight in the seventh cycle.

Similarly, the multiplier 1117B receives the input operand from the input register file 1113B and the weight operand from the weight register file 1115B. The multiplier 1117B sequentially performs seven cycles of multiplication operations. In each cycle, the multiplier 1117B multiplies an input element and a weight and generates a product. The multiplier 1117C receives the input operand from the input register file 1113C and the weight operand from the weight register file 1115C. The multiplier 1117C sequentially performs seven cycles of multiplication operations. In each cycle, the multiplier 1117C multiplies an activation and a weight and generates a product. The multiplier 1117D is inactive (shown as dash lines in FIG. 11) and can be gated to save power.

Example Data Reuse

FIG. 12 illustrates reuse of activations across multiple strides along X dimension, in accordance with various embodiments. FIG. 12 shows MAC rounds of a PE: PE0, which may be PE0 in Column0 or Column1 in FIG. 9. Each stride is a MAC round. The MAC rounds are in a convolution of a frontend conventional layer. For the purpose of illustration, the input tensor of the convolution has a spatial size of 224×224×3, and the kernel of the convolution has a spatial size of 7×7. The stride size of the convolution is two, meaning the filter moves two points along the X dimension from a stride to the next stride. The PE in FIG. 12 performs 112 MAC rounds. For simplicity, FIG. 12 shows the first four rounds (Round0-Round4) and the last round (Round112). “SB” represents a distinct register file storage, e.g., a distinct register file. PE0 is associated with four register files: SB0-SB3. In some embodiment, each register file is for a different multiplier in PE0.

FIG. 12 illustrates data load into the register files of PE0 that has a sliding window pattern along X dimension across the MAC rounds. Each register file stores seven activations in a single round. Each activation is represented by a (Z, Y, X) coordinate in FIG. 12. The same register file stores different activations in different rounds. Tasking SB0 for example, SB0 stores six activations (0,0, 0-6) in Round®, store (0,0, 2-8) in Round1, stores (0,0, 4-10) in Round2, and so on. The distance along X dimension between the first activation in SB0 in a round and the first activation in SB0 in the immediately previous round is two, i.e., the stride size of the convolution. Also, the first five activations in the round are the same as the last five activations in the immediately previous round.

FIG. 12 shows X dimension striding. Data rotation happens within each data lane of PE0 and therefore, can be realized by a shift in the bytes of the storage using the stride size. Across two adjacent MAC rounds, a shift of two is applied to the X coordinates of the activations. For the purpose of simplicity, an activation takes a byte in embodiments of FIG. 12. In other embodiments, an activation may take multiple bytes. Even though FIG. 12 shows seven bytes for each register file in a single round, data load to register files can be at a larger granularity, such as 8 bytes, 16 bytes, 32 bytes, and so on. In an example where each entry in a register file is of 16-byte length, 16 activations can be stored in a register file in each data load round. The sliding shift provides the numbers of bytes determined by the stride value. Across the different data lanes, the same amount of X dimension sliding shift is being applied for different Y coordinates for the subsequent data load rounds.

FIG. 13 illustrates reuse of activations across multiple strides along Y dimension, in accordance with various embodiments. FIG. 13 shows MAC rounds of two PEs: PE0 and PE1, which may be PE0 and PE1 in Column0 or Column1 in FIG. 9. The strides along Y dimension may happen after strides along X dimension (e.g., the strides in FIG. 12). For instance, after the strides along X dimension reaches the end (e.g., the last activation along X dimension), X coordinate may reset (i.e., goes back to the first activation along X dimension) with a movement of two activations along Y dimension. Each stride is a MAC round. The MAC rounds are in a convolution of a frontend conventional layer. For illustration, the input tensor of the convolution has a spatial size of 224×224×3, and the kernel of the convolution has a spatial size of 7×7. The stride size of the convolution is two, meaning the filter moves two points along the Y dimension from a stride to the next stride. Each PE in FIG. 13 performs 112 MAC rounds. For simplicity, FIG. 13 shows the first four rounds (Round0-Round4) and the last round (Round112). “SB” represents a distinct register file storage, e.g., a distinct register file. Each PE is associated with four register files: SB0-SB3. In some embodiment, each register file is for a different multiplier in the PE.

For striding along Y dimension, shift across the 4 data lanes of 2 different PEs may be needed. This is because, the seven Y coordinates for the first load round is already distributed across the 4 data lanes of PE0 and 3 data lanes of PE1. The fourth data lane of the PE1 is empty as part of the first load round as shown in FIG. 13. Arrows shown in FIG. 13 to indicate which data lane is to determine the start of the read. In the next load round, the values stored in SB0 and SB1 of PE0 are popped out and the arrow is moved to the start of SB2 of PE0. To complete the MAC operation in the Y dimension, seven Y points are needed, which requires bringing in two new Y points and populating SB3 of PE1 and SB0 of PE0 in the second load round. This cyclic shift is also part to the sliding window shift optimization used to realize the IY striding by maximizing the data reuse from the register file storage across 2 PEs and reducing the load bandwidth across the MAC rounds. The load bandwidth reduction can be even higher for convolutions with larger kernels.

In some embodiments, the datastore (e.g., the datastore 330), from which data can be fed into the PEs, may have a dense mode to utilize the sliding window shift optimization, which allows the write module 340 to retrieve 16 bytes of activations across the various load rounds. This can reduce the number of reads performed to the datastore and further reduces the power of the data distribution network and improves the overall energy efficiency of the DNN accelerator.

Example Activation Padding

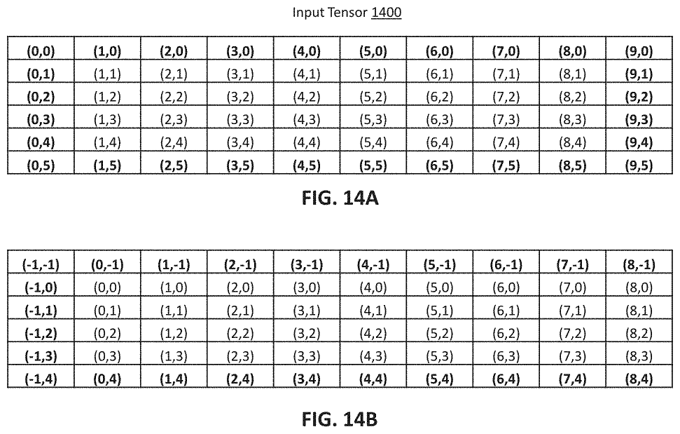

FIGS. 14A and 14B illustrates activation padding, in accordance with various embodiments. FIG. 14A shows an input tensor that include pad elements, which are bolded in FIG. 14A. For purpose of illustration, FIG. 14A shows one channel of the input tensor, which is a 9×5 array. The pad elements are arranged at the left, right, top, and bottom edges of the input tensor. The pad count is 1, i.e., one column is added to the left, one column is added to the right, one row is added to the left, and one row is added to the right. The pad elements may be added to the input tensor by the padding module 350. The other activations of the input tensor may be from the datastore 330. In FIG. 14A, all the activations in the input tensor 1400 are represented by their (X,Y) coordinates.

FIG. 14B illustrates a result of computation by the padding module 350 to determine positions of pad elements in the input tensor 1400. The padding module 350 subtract the pad count in X and Y dimension (i.e., (1,1)) from the (X,Y) coordinate of each activation and produces the result in FIG. 14B. The padding module 350 may use the result to determine where to add pad elements. For instance, for the left edge of the input tensor, the padding module 350 may determine to add a pad element to a position based on that the subtraction result for the position is smaller than the Y pad count. For the right edge of the input tensor, the padding module 350 may determine to add a pad element to a position based on that the subtraction result for the position is larger than the largest X coordinate (i.e., 8 as shown in FIG. 14A). For the top edge of the input tensor, the padding module 350 may determine to add a pad element to a position based on that the subtraction result for the position is smaller than the X pad count. For the bottom edge of the input tensor, the padding module 350 may determine to add a pad element to a position based on that the subtraction result for the position is larger than the largest Y coordinate (i.e., 4 as shown in FIG. 14A). After identifying the positions to add pad elements, the padding module 350 may place pad elements at these positions. The padding module 350 may also place activations read from the datastore to t he other positions.

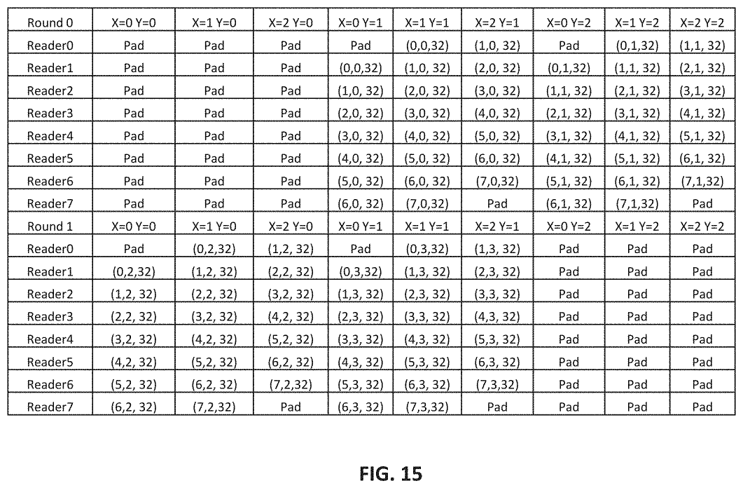

FIG. 15 illustrates data reading from a datastore for a padded tensor, in accordance with various embodiments. In the embodiments of FIG. 15, an 8×4 tensor is padded with a pad count of 1, i.e., one column is added to the left, one column is added to the right, one row is added to the left, and one row is added to the right. Eight readers (Reader0-Reader7) are activated to fetch activations in each round. The readers do not need to fetch activations for the positions shown as “Pad.” Instead, the padding module 350 can add pad elements into these positions. This can reduce power and load bandwidth of the DNN accelerator.

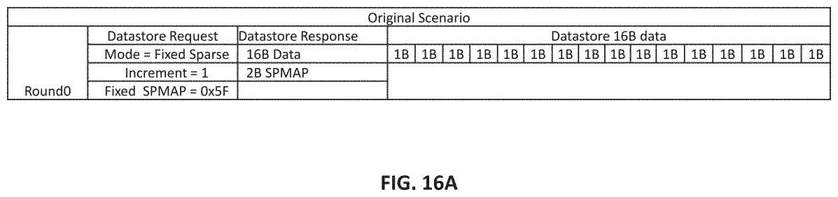

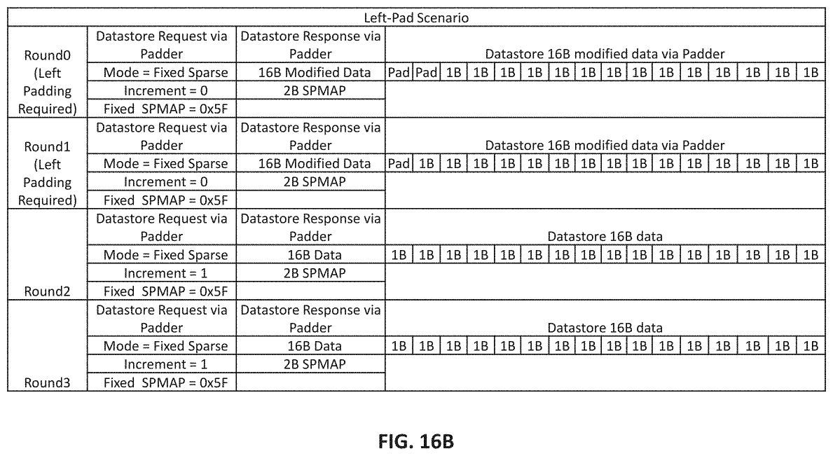

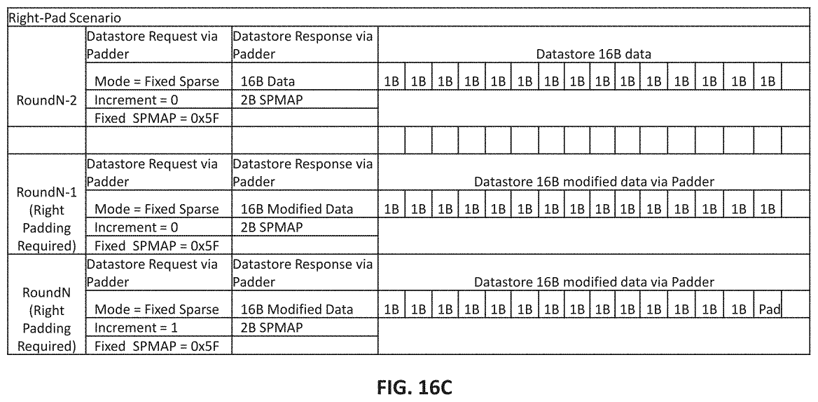

FIGS. 16A-16C illustrates loading data into a PE array through the padding module 350, in accordance with various embodiments. FIG. 16 illustrates an original scenario for a first convolutional layer without padding. Datastore inputs may be be set to an increment of one based on the stride size and fixed sparsity bitmap mode would be enabled. The fixed sparsity bitmap may be 0×5F for a 5×5 kernel, for example. These inputs are set as part of the request to the datastore and the output from the datastore is a 16-byte data and a 2-byte sparsity bitmap (shown as SPMAP in FIG. 16A).

FIG. 16B shows a scenario where left padding is performed by the padding module 350. The read request for reading data from the datastore may be sent through the padding module 350, which modifies the input shown in FIG. 16A. The padding module 350 changes the increment to 0 for the first and second load rounds. The output from the datastore is also sent through the padding module 350. THE padding module 350 inserts the pad values into the data stream by shifting it right by the number of pad bytes to be inserted. In load round 0, two pad bytes need to be inserted, so the output data by shifted right by 2 and pad values are inserted at the beginning of the data. Since the X stride is 1, after load round 0, the next load round will only require one pad byte to be inserted into the output stream. During every load round in the original scenario, the datastore will shift its internal read pointer based on the increment count. But for the left padding load scenarios in FIG. 16B, load round 0 and 1 will need to insert pad bytes and the actual data is not being used until we complete the pad rounds and therefore, the increments are cleared during these rounds as shown in FIG. 16B

FIG. 16C shows a right padding insertion that is similar to the left padding scenario in FIG. 16B, but the padding module 350 may need to be notified by the reader has reached the end of the tensor for the fetch of all X coordinates. Then, the padding module 350 may extend the last load round by adding more rounds for the right pad insertion. For the last load round, the padding module 350 changes the increment to zero else the datastore will be reach the end of the data stream and complete. This scheme allows the padding module 350 to extend the load rounds and have the datastore return the same data bytes for these extended load rounds. As shown in FIG. 16C, load rounds N−1 and N were added to enable the right pad insertion by shifting left by stride amount. For the Nth load round, the increment set to 1, which can allow the datastore to complete the data stream.

Example Method of Accelerating Deep Learning

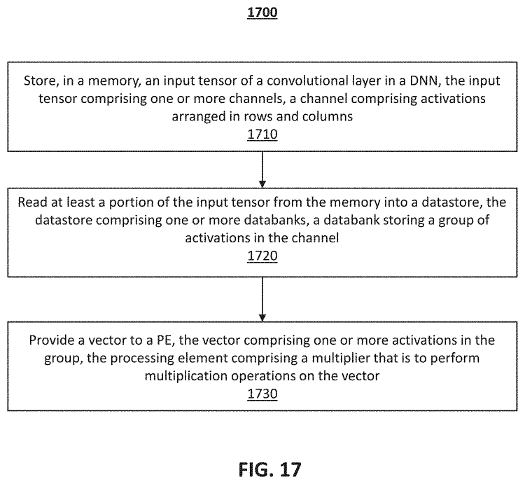

FIG. 17 is a flowchart showing a method 1700 of accelerating deep learning, in accordance with various embodiments. The method 1700 may be performed by the compute block 300 in FIG. 3. Although the method 1700 is described with reference to the flowchart illustrated in FIG. 17, many other methods for accelerating deep learning may alternatively be used. For example, the order of execution of the steps in FIG. 17 may be changed. As another example, some of the steps may be changed, eliminated, or combined.

The compute block 300 stores 1710, in a memory, an input tensor of a convolutional layer in a DNN. The input tensor comprises one or more channels. A channel comprises activations arranged in rows and columns. In some embodiments, the DNN further comprises one or more other convolutional layers. The convolutional layer may be arranged before the one or more other convolutional layers in the DNN.

The compute block 300 reads 1720 at least a portion of the input tensor from the memory into a datastore. The datastore comprises one or more databanks. A databank stores a group of activations in the channel. In some embodiments, the activations in the group are in one of the rows of the channel.

The compute block 300 provides 1730 a vector to a PE, the vector comprising one or more activations in the group, the PE comprising a multiplier that is to perform multiplication operations on the vector. In some embodiments, the convolutional layer has a kernel comprising weights arranged in rows and columns. A number of activations in the vector equals a number of weights in a row of the kernel. The multiplier is to perform the multiplication operations on the vector and a weight vector. The weight vector may include weights in one of the rows of the kernel.

In some embodiments, the vector is a first vector in the input tensor. The multiplier is a first multiplier in the PE. The compute block 300 provides a second vector to the PE. The second vector may include one or more other activations stored in another databank of the datastore. A second multiplier of the PE is to perform multiplication operations on the second vector. The one or more activations in the group are in a different row of the input tensor from the one or more other activations.

In some embodiments, the vector is a first vector in the input tensor. The multiplier is to perform multiplication operations on the first vector at a first time. The multiplier is to perform multiplication operations on a second vector in the input tensor at a second time that is different from the first time. The second vector comprises one or more same activations as the first vector. The compute block 300 may read an activation vector from the databank into a register file of the PE. The activation vector may include activations in the first vector and activations in the second vector. The one or more same activations may be selected based on a stride size of the convolutional layer. In an embodiment, the multiplier may be to perform multiplication operations on a third vector in the input tensor at a third time. The second time may be after the first time and before the third time. The third vector may include one or more same activation as the first vector or the second vector.

In some embodiments, the multiplier is a first multiplier of the PE. The vector is a first vector in the input tensor. The input tensor further comprises a second vector and a third vector that have one or more different activations from the first vector. The first multiplier is to perform the multiplication operations on the first vector in a first operation round of the PE and is to perform multiplication operations on a second vector in a second operation round of the PE. A second multiplier of the PE is to perform multiplication operations on a third vector in the first operation round and in the second operation round. The first multiplier may be configured to perform multiplication operations on the second vector in a third operation round of the PE. The second operation round may be between the first operation round and the third operation round

In some embodiments, a sequence of activations is read from the datastore into a storage unit of the PE. A number of the activations in the sequence is larger than the number of the weights in the row of the kernel. A bitmap is read from the datastore into the storage unit of the PE. The bitmap comprises a sequence of bits. A number of bits having values of one in the bitmap equals the number of the weights in the row of the kernel. The bitmap is to be applied on the sequence of activations to extract the one or more activations from the group. The sequence of activations may start with a first activation and be read from the datastore at a first time. A different sequence of activation may start with a second activation and be read from the datastore at a second time that is different from the first time. A position of the second activation in the input tensor may be determined based on a position of the first activation in the input tensor and a stride size of the convolutional layer.

In some embodiments, a sequence of activations is read from the datastore. The sequence of activations is modified by adding one or more pad elements into the sequence to generate a new sequence of activations. The one or more pad elements have a predetermined value. The new sequence of activations is written into a storage unit of the PE. A bitmap is transferred from the datastore into the storage unit of the PE. The bitmap comprises a sequence of bits that includes one or more bits have a value of zero and one or more bits have a value of one. The vector is generated based on the bitmap and the new sequence of activations. The sequence of activations may be from the datastore at a first time. The one or more pad elements may include two pad elements. The sequence of activations may be read from the datastore at a second time that is later than the first time. After the sequence of activations is read from the datastore at the second time, another new sequence of activations may be generated by adding one pad element into the sequence of activations.

Example DNN Accelerator

FIG. 18 is a block diagram of an example DNN accelerator 1800, in accordance with various embodiments. The DNN accelerator 1800 can run DNNs, e.g., the DNN 100 in FIG. 1. The DNN accelerator 1800 includes a memory 1810, a DMA (direct memory access) engine 1820, and compute blocks 1830. An example of a compute block 1830 is the compute block 300 in FIG. 3. In other embodiments, alternative configurations, different or additional components may be included in the DNN accelerator 1800. For instance, the DNN accelerator 1800 may include more than one memory 1810 or more than one DMA engine 1820. Further, functionality attributed to a component of the DNN accelerator 1800 may be accomplished by a different component included in the DNN accelerator 1800 or by a different system.

The memory 1810 stores data to be used by the compute blocks 1830 to perform deep learning operations in DNN models. Example deep learning operations include convolutions (also referred to as “convolutional operations”), pooling operations, elementwise operations, other types of deep learning operations, or some combination thereof. The memory 1810 may be a main memory of the DNN accelerator 1800. In some embodiments, the memory 1810 includes one or more DRAMs (dynamic random-access memory). For instance, the memory 1810 may store the input tensor, convolutional kernels, or output tensor of a convolution in a convolutional layer of a DNN, e.g., the convolutional layer 180. The output tensor can be transmitted from a local memory of a compute block 1830 to the memory 1810 through the DMA engine 1820.

The DMA engine 1820 facilitates data transfer between the memory 1810 and local memories of the compute blocks 1830. For example, the DMA engine 1820 can read data from the memory 1810 and write data into a local memory of a compute block 1830. As another example, the DMA engine 1820 can read data from a local memory of a compute block 1830 and write data into the memory 1810. The DMA engine 1820 provides a DMA feature that allows the compute block 1830 to initiate data transfer between the memory 1810 and the local memories of the compute blocks 1830 and to perform other operations while the data transfer is in being conducted. In some embodiments, the DMA engine 1820 may read tensors from the memory 1810, modify the tensors in a way that is optimized for the compute block 1830 before it writes the tensors into the local memories of the compute blocks 1830.

The compute blocks 1830 perform computation for deep learning operations. A compute block 1830 may run the operations in a DNN layer, or a portion of the operations in the DNN layer. A compute block 1830 may perform convolutions, e.g., standard convolution or depthwise convolution. In some embodiments, the compute block 1830 receive an input tensor and one or more convolutional kernels and performs a convolution with the input tensor and convolutional kernels. The result of the convolution may be an output tensor, which can be further computed, e.g., by the compute block 1830 or another compute block. An example of the compute block 1830 is the compute block 300 in FIG. 3. In some embodiments, the operations of the DNN layers may be run by multiple compute blocks 1830 in parallel. For instance, multiple compute blocks 1830 may each perform a portion of a workload for a convolution. Data may be shared between the compute blocks 1830.

Example PE Array

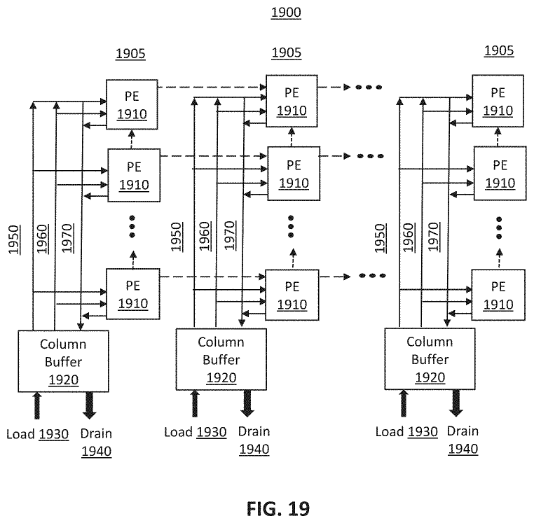

FIG. 19 illustrates a PE array 1900, in accordance with various embodiments. The PE array 1900 is an embodiment of the PE array 320 in FIG. 3. The PE array 1900 includes a plurality of PEs 1910 (individually referred to as “PE 1910”). The PEs 1910 perform MAC operations. The PEs 1910 may also be referred to as neurons in the DNN. Each PE 1910 has two input signals 1950 and 1960 and an output signal 1970. The input signal 1950 is at least a portion of an IFM to the layer. The input signal 1960 is at least a portion of a filter of the layer. In some embodiments, the input signal 1950 of a PE 1910 includes one or more input operands, and the input signal 1960 includes one or more weight operand.

Each PE 1910 performs an MAC operation on the input signals 1950 and 1960 and outputs the output signal 1970, which is a result of the MAC operation. Some or all of the input signals 1950 and 1960 and the output signal 1970 may be in an integer format, such as INT8, or floating-point format, such as FP16 or BF16. For purpose of simplicity and illustration, the input signals and output signal of all the PEs 1910 have the same reference numbers, but the PEs 1910 may receive different input signals and output different output signals from each other. Also, a PE 1910 may be different from another PE 1910, e.g., including more, fewer, or different components.

As shown in FIG. 19, the PEs 1910 are connected to each other, as indicated by the dash arrows in FIG. 19. The output signal 1970 of an PE 1910 may be sent to many other PEs 1910 (and possibly back to itself) as input signals via the interconnections between PEs 1910. In some embodiments, the output signal 1970 of an PE 1910 may incorporate the output signals of one or more other PEs 1910 through an accumulate operation of the PE 1910 and generates an internal partial sum of the PE array. More details about the PEs 1910 are described below in conjunction with FIG. 19B.

In the embodiments of FIG. 19, the PEs 1910 are arranged into columns 1905 (individually referred to as “column 1905”). The input and weights of the layer may be distributed to the PEs 1910 based on the columns 1905. Each column 1905 has a column buffer 1920. The column buffer 1920 stores data provided to the PEs 1910 in the column 1905 for a short amount of time. The column buffer 1920 may also store data output by the last PE 1910 in the column 1905. The output of the last PE 1910 may be a sum of the MAC operations of all the PEs 1910 in the column 1905, which is a column-level internal partial sum of the PE array 1900. In other embodiments, input and weights may be distributed to the PEs 1910 based on rows in the PE array 1900. The PE array 1900 may include row buffers in lieu of column buffers 1920. A row buffer may store input signals of the PEs in the corresponding row and may also store a row-level internal partial sum of the PE array 1900.

As shown in FIG. 19, each column buffer 1920 is associated with a load 1930 and a drain 1940. The data provided to the column 1905 is transmitted to the column buffer 1920 through the load 1930, e.g., through upper memory hierarchies, e.g., the memory 310 in FIG. 3. The data generated by the column 1905 is extracted from the column buffers 1920 through the drain 1940. In some embodiments, data extracted from a column buffer 1920 is sent to upper memory hierarchies, e.g., the memory 310 in FIG. 3, through the drain operation. In some embodiments, the drain operation does not start until all the PEs 1910 in the column 1905 has finished their MAC operations. In some embodiments, the load 1930 or drain 1940 may be controlled by the controlling module 340. Even though not shown in FIG. 19, one or more columns 1905 may be associated with an external adder assembly.

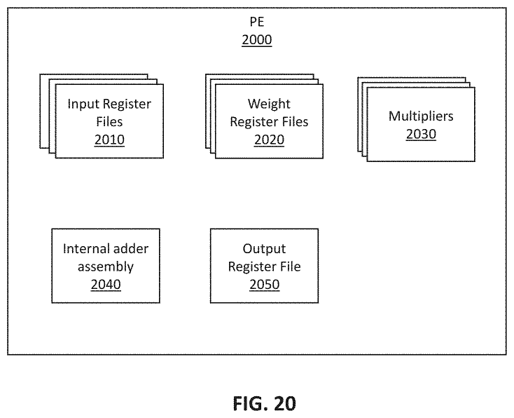

FIG. 20 is a block diagram of a PE 2000, in accordance with various embodiments. The PE 2000 may be an embodiment of the PE 1910 in FIG. 19. The PE 2000 includes input register files 2010 (individually referred to as “input register file 2010”), weight registers file 2020 (individually referred to as “weight register file 2020”), multipliers 2030 (individually referred to as “multiplier 2030”), an internal adder assembly 2040, and an output register file 2050. In other embodiments, the PE 2000 may include fewer, more, or different components. For instance, the PE 2000 may include multiple output register files 2050.

The input register files 2010 temporarily store input operands for MAC operations by the PE 2000. In some embodiments, an input register file 2010 may store a single input operand at a time. In other embodiments, an input register file 2010 may store multiple input operand or a portion of an input operand at a time. An input operand includes a plurality of input elements in an IFM. The input elements of an input operand may be stored sequentially in the input register file 2010 so the input elements can be processed sequentially. In some embodiments, each input element in the input operand may be from a different input channel of the IFM. The input operand may include an input element from each of the input channels of the IFM, and the number of input element in an input operand may equal the number of the input channels. The input elements in an input operand may have the same XY coordinates, which may be used as the XY coordinates of the input operand. For instance, all the input elements of an input operand may be X0Y0, X0Y1, X1Y1, etc.

The weight register file 2020 temporarily stores weight operands for MAC operations by the PE 2000. The weight operands include weights in the filters of the DNN layer. In some embodiments, the weight register file 2020 may store a single weight operand at a time. other embodiments, an input register file 2010 may store multiple weight operands or a portion of a weight operand at a time. A weight operand may include a plurality of weights. The weights of a weight operand may be stored sequentially in the weight register file 2020 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 2020 may be the same or similar as an input register file 2010, e.g., having the same size, etc. The PE 2000 may include a plurality of register files, some of which are designated as the input register files 2010 for storing input operands, some of which are designated as the weight register files 2020 for storing weight operands, and some of which are designated as the output register file 2050 for storing output operands. In other embodiments, register files in the PE 2000 may be designated for other purposes, e.g., for storing scale operands used in elementwise add operations, etc. The designation of the register files may be controlled by the controlling module 340.

The multipliers 2030 perform multiplication operations on input operands and weight operands. A multiplier 2030 may perform a sequence of multiplication operations on a single input operand and a single weight operand and generates a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 2030 may perform multiplication operations simultaneously. These multiplication operations may be referred to as a round of multiplication operations. In a round of multiplication operations by the multipliers 2030, each of the multipliers 2030 may use a different input operand and a different weight operand. The different input operands or weight operands may be stored in different register files of the PE 2000. For instance, a first multiplier 2030 uses a first input operand (e.g., stored in a first input register file 2010) and a first weight operand (e.g., stored in a first weight register file 2020), versus a second multiplier 2030 uses a second input operand (e.g., stored in a second input register file 2010) and a second weight operand (e.g., stored in a second weight register file 2020), a third multiplier 2030 uses a third input operand (e.g., stored in a third input register file 2010) and a third weight operand (e.g., stored in a third weight register file 2020), and so on. For an individual multiplier 2030, the round of multiplication operations may include a plurality of cycles. A cycle includes a multiplication operation on an input element and a weight.

The multipliers 2030 may perform multiple rounds of multiplication operations. A multiplier 2030 may use the same weight operand but different input operands in different rounds. For instance, the multiplier 2030 performs a sequence of multiplication operations on a first input operand stored in a first input register file in a first round, versus a second input operand stored in a second input register file in a second round. In the second round, a different multiplier 2030 may use the first input operand and a different weight operand to perform another sequence of multiplication operations. That way, the first input operand is reused in the second round. The first input operand may be further reused in additional rounds, e.g., by additional multipliers 2030. More details regarding reuse of input operands are provided below in conjunction with FIGS. 9A-I and FIGS. 10A-C.

The internal adder assembly 2040 includes adders inside the PE 2000, i.e., internal adders. The internal adder assembly 2040 may perform accumulation operations on two or more products operands from multipliers 2030, and produce an output operand of the PE 2000. In some embodiments, the internal adders are arranged in a sequence of tiers. A tier includes one or more internal adders. For the first tier of the internal adder assembly 2040, an internal adder may receive product operands from two or more multipliers 2030 and generate a sum operand through a sequence of accumulation operations. Each accumulation operation produces a sum of two or more products, each of which is from a different multiplier 2030. The sum operand includes a sequence of sums, each of which is a result of an accumulation operation and corresponds to a depthwise channel. For the other tier(s) of the internal adder assembly 2040, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 2040 may include a single internal adder, which produces the output operand of the PE 2000. More details regarding internal adder assembly are described below in conjunction with FIG. 10.

The output register file 2050 stores output operands of the PE 2000. In some embodiments, the output register file 2050 may store an output operand at a time. In other embodiments, the output register file 2050 may store multiple output operand or a portion of an output operand at a time. An output operand includes a plurality of output elements in an IFM. The output elements of an output operand may be stored sequentially in the output register file 2050 so the output elements can be processed sequentially. In some embodiments, each output element in the output operand corresponds to a different depthwise channel and is an element of a different output channel of the OFM of the depthwise convolution. The number of output element in an output operand may equal the number of the depthwise channels of the depthwise convolution.

Example Deep Learning Environment

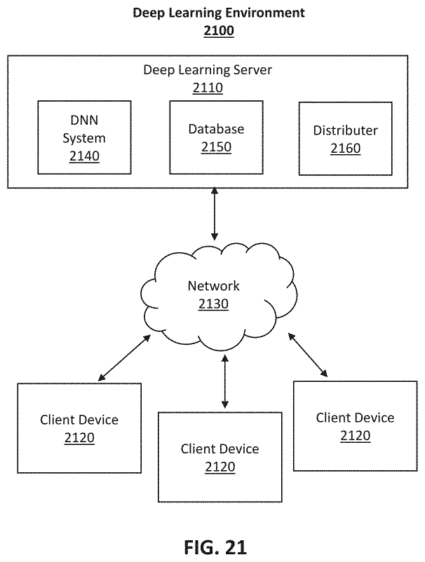

FIG. 21 illustrates a deep learning environment 2100, in accordance with various embodiments. The deep learning environment 2100 includes a deep learning server 2110 and a plurality of client devices 2120 (individually referred to as client device 2120). The deep learning server 2110 is connected to the client devices 2120 through a network 2130. In other embodiments, the deep learning environment 2100 may include fewer, more, or different components.

The deep learning server 2110 trains deep learning models using neural networks. A neural network is structured like the human brain and consists of artificial neurons, also known as nodes. These nodes are stacked next to each other in 3 types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The deep learning server 2110 can use various types of neural networks, such as DNN, recurrent neural network (RNN), generative adversarial network (GAN), long short-term memory network (LSTMN), and so on. During the process of training the deep learning models, the neural networks use unknown elements in the input distribution to extract features, group objects, and discover useful data patterns. The deep learning models can be used to solve various problems, e.g., making predictions, classifying images, and so on. The deep learning server 2110 may build deep learning models specific to particular types of problems that need to be solved. A deep learning model is trained to receive an input and outputs the solution to the particular problem.

In FIG. 21, the deep learning server 2110 includes a DNN system 2140, a database 2150, and a distributer 2160. The DNN system 2140 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. In some embodiments, the DNN system 2140 trains DNNs through knowledge distillation, e.g., dense-connection based knowledge distillation. The trained DNNs may be used on low memory systems, like mobile phones, IOT edge devices, and so on. An embodiment of the DNN system 2140 is the DNN accelerator 200 described above in conjunction with FIG. 2.

The database 2150 stores data received, used, generated, or otherwise associated with the deep learning server 2110. For example, the database 2150 stores a training dataset that the DNN system 2140 uses to train DNNs. In an embodiment, the training dataset is an image gallery that can be used to train a DNN for classifying images. The training dataset may include data received from the client devices 2120. As another example, the database 2150 stores hyperparameters of the neural networks built by the deep learning server 2110.

The distributer 2160 distributes deep learning models generated by the deep learning server 2110 to the client devices 2120. In some embodiments, the distributer 2160 receives a request for a DNN from a client device 2120 through the network 2130. The request may include a description of a problem that the client device 2120 needs to solve. The request may also include information of the client device 2120, such as information describing available computing resource on the client device. The information describing available computing resource on the client device 2120 can be information indicating network bandwidth, information indicating available memory size, information indicating processing power of the client device 2120, and so on. In an embodiment, the distributer may instruct the DNN system 2140 to generate a DNN in accordance with the request. The DNN system 2140 may generate a DNN based on the information in the request. For instance, the DNN system 2140 can determine the structure of the DNN and/or train the DNN in accordance with the request.

In another embodiment, the distributer 2160 may select the DNN from a group of pre-existing DNNs based on the request. The distributer 2160 may select a DNN for a particular client device 2120 based on the size of the DNN and available resources of the client device 2120. In embodiments where the distributer 2160 determines that the client device 2120 has limited memory or processing power, the distributer 2160 may select a compressed DNN for the client device 2120, as opposed to an uncompressed DNN that has a larger size. The distributer 2160 then transmits the DNN generated or selected for the client device 2120 to the client device 2120.

In some embodiments, the distributer 2160 may receive feedback from the client device 2120. For example, the distributer 2160 receives new training data from the client device 2120 and may send the new training data to the DNN system 2140 for further training the DNN. As another example, the feedback includes an update of the available computing resource on the client device 2120. The distributer 2160 may send a different DNN to the client device 2120 based on the update. For instance, after receiving the feedback indicating that the computing resources of the client device 2120 have been reduced, the distributer 2160 sends a DNN of a smaller size to the client device 2120.

The client devices 2120 receive DNNs from the distributer 2160 and applies the DNNs to perform machine learning tasks, e.g., to solve problems or answer questions. In various embodiments, the client devices 2120 input images into the DNNs and use the output of the DNNs for various applications, e.g., visual reconstruction, augmented reality, robot localization and navigation, medical diagnosis, weather prediction, and so on. A client device 2120 may be one or more computing devices capable of receiving user input as well as transmitting and/or receiving data via the network 2130. In one embodiment, a client device 2120 is a conventional computer system, such as a desktop or a laptop computer. Alternatively, a client device 2120 may be a device having computer functionality, such as a personal digital assistant (PDA), a mobile telephone, a smartphone, an autonomous vehicle, or another suitable device. A client device 2120 is configured to communicate via the network 2130. In one embodiment, a client device 2120 executes an application allowing a user of the client device 2120 to interact with the deep learning server 2110 (e.g., the distributer 2160 of the deep learning server 2110). The client device 2120 may request DNNs or send feedback to the distributer 2160 through the application. For example, a client device 2120 executes a browser application to enable interaction between the client device 2120 and the deep learning server 2110 via the network 2130. In another embodiment, a client device 2120 interacts with the deep learning server 2110 through an application programming interface (API) running on a native operating system of the client device 2120, such as IOS® or ANDROID™.

In an embodiment, a client device 2120 is an integrated computing device that operates as a standalone network-enabled device. For example, the client device 2120 includes display, speakers, microphone, camera, and input device. In another embodiment, a client device 2120 is a computing device for coupling to an external media device such as a television or other external display and/or audio output system. In this embodiment, the client device 2120 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 2120 may be configured to be compatible with a generic external media device that does not have specialized software, firmware, or hardware specifically for interacting with the client device 2120.

The network 2130 supports communications between the deep learning server 2110 and client devices 2120. The network 2130 may comprise any combination of local area and/or wide area networks, using both wired and/or wireless communication systems. In one embodiment, the network 2130 may use standard communications technologies and/or protocols. For example, the network 2130 may include communication links using technologies such as Ethernet, 21010.11, worldwide interoperability for microwave access (WiMAX), 3G, 4G, code division multiple access (CDMA), digital subscriber line (DSL), etc. Examples of networking protocols used for communicating via the network 2130 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 2130 may be represented using any suitable format, such as hypertext markup language (HTML) or extensible markup language (XML). In some embodiments, all or some of the communication links of the network 2130 may be encrypted using any suitable technique or techniques.

Example DNN System

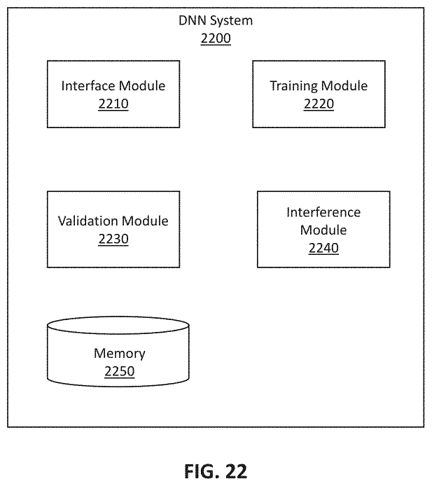

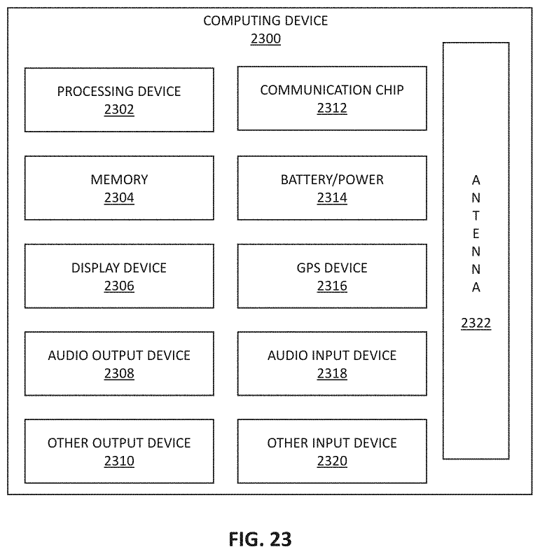

FIG. 22 is a block diagram of an example DNN system 2200, in accordance with various embodiments. The whole DNN system 2200 or a part of the DNN system 2200 may be implemented in the computing device 2300 in FIG. 23. The DNN system 2200 trains DNNs for various tasks, such as image classification, learning relationships between biological cells (e.g., DNA, proteins, etc.), control behaviors for devices (e.g., robots, machines, etc.), and so on. The DNN system 2200 includes an interface module 2210, a training module 2220, a validation module 2230, an inference module 2240, and a memory 2250. In other embodiments, alternative configurations, different or additional components may be included in the DNN system 2200. Further, functionality attributed to a component of the DNN system 2200 may be accomplished by a different component included in the DNN system 2200 or a different system. The DNN system 2200 or a component of the DNN system 2200 (e.g., the training module 2220 or inference module 2240) may include the computing device 2300.

The interface module 2210 facilitates communications of the DNN system 2200 with other systems. For example, the interface module 2210 establishes communications between the DNN system 2200 with an external database to receive data that can be used to train DNNs or input into DNNs to perform tasks. As another example, the interface module 2210 supports the DNN system 2200 to distribute DNNs to other systems, e.g., computing devices configured to apply DNNs to perform tasks.

The training module 2220 trains DNNs by using a training dataset. The training module 2220 forms the training dataset. In an embodiment where the training module 2220 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 2230 to validate performance of a trained DNN. The portion of the training dataset not including the tuning subset and the validation subset may be used to train the DNN.

The training module 2220 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 22, 220, 500, 2200, or even larger.

The training module 2220 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 2220 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 2220 defines the architecture of the DNN, the training module 2220 inputs a training dataset into the DNN. The training dataset includes a plurality of training samples. An example of a training sample includes an object in an image and a ground-truth label of the object. The training module 2220 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 2220 uses a cost function to minimize the error.

The training module 2220 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 2220 finishes the predetermined number of epochs, the training module 2220 may stop updating the parameters in the DNN. The DNN having the updated parameters is referred to as a trained DNN.

The validation module 2230 verifies accuracy of trained DNNs. In some embodiments, the validation module 2230 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 2230 may determine an accuracy score measuring the precision, recall, or a combination of precision and recall of the DNN. The validation module 2230 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 2230 may compare the accuracy score with a threshold score. In an example where the validation module 2230 determines that the accuracy score of the augmented model is lower than the threshold score, the validation module 2230 instructs the training module 2220 to re-train the DNN. In one embodiment, the training module 2220 may iteratively re-train the DNN until the occurrence of a stopping condition, such as the accuracy measurement indication that the DNN may be sufficiently accurate, or a number of training rounds having taken place.

The inference module 2240 applies the trained or validated DNN to perform tasks. For instance, the inference module 2240 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 2240 distributes the DNN to other systems, e.g., computing devices in communication with the DNN system 2200, for the other systems to apply the DNN to perform the tasks.

The memory 2250 stores data received, generated, used, or otherwise associated with the DNN system 2200. For example, the memory 2250 stores the datasets used by the training module 2220 and validation module 2230. The memory 2250 may also store data generated by the training module 2220 and validation module 2230, such as the hyperparameters for training DNNs, internal parameters of trained DNNs (e.g., values of tunable parameters of activation functions, such as Fractional Adaptive Linear Units (FALUs)), etc. In the embodiment of FIG. 22, the memory 2250 is a component of the DNN system 2200. In other embodiments, the memory 2250 may be external to the DNN system 2200 and communicate with the DNN system 2200 through a network.

Example Computing Device

FIG. 23 is a block diagram of an example computing device 2300, in accordance with various embodiments. In some embodiments, the computing device 2300 can be used as the DNN system 1300 in FIG. 13. A number of components are illustrated in FIG. 23 as included in the computing device 2300, but any one or more of these components may be omitted or duplicated, as suitable for the application. In some embodiments, some or all of the components included in the computing device 2300 may be attached to one or more motherboards. In some embodiments, some or all of these components are fabricated onto a single system on a chip (SoC) die. Additionally, in various embodiments, the computing device 2300 may not include one or more of the components illustrated in FIG. 23, but the computing device 2300 may include interface circuitry for coupling to the one or more components. For example, the computing device 2300 may not include a display device 2306, but may include display device interface circuitry (e.g., a connector and driver circuitry) to which a display device 2306 may be coupled. In another set of examples, the computing device 2300 may not include an audio input device 2318 or an audio output device 2308, but may include audio input or output device interface circuitry (e.g., connectors and supporting circuitry) to which an audio input device 2318 or audio output device 2308 may be coupled.

The computing device 2300 may include a processing device 2302 (e.g., one or more processing devices). The processing device 2302 processes electronic data from registers and/or memory to transform that electronic data into other electronic data that may be stored in registers and/or memory. The computing device 2300 may include a memory 2304, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2304 may include memory that shares a die with the processing device 2302. In some embodiments, the memory 2304 includes one or more non-transitory computer-readable media storing instructions executable to perform operations for deep learning, e.g., the method 1000 described above in conjunction with FIG. 10 or some operations performed by the PE 500 described above in conjunction with FIG. 5. The instructions stored in the one or more non-transitory computer-readable media may be executed by the processing device 2302.

In some embodiments, the computing device 2300 may include a communication chip 2312 (e.g., one or more communication chips). For example, the communication chip 2312 may be configured for managing wireless communications for the transfer of data to and from the computing device 2300. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2312 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2312 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2312 may operate in accordance with other wireless protocols in other embodiments. The computing device 2300 may include an antenna 2322 to facilitate wireless communications and/or to receive other wireless communications (such as AM or FM radio transmissions).

In some embodiments, the communication chip 2312 may manage wired communications, such as electrical, optical, or any other suitable communication protocols (e.g., the Ethernet). As noted above, the communication chip 2312 may include multiple communication chips. For instance, a first communication chip 2312 may be dedicated to shorter-range wireless communications such as Wi-Fi or Bluetooth, and a second communication chip 2312 may be dedicated to longer-range wireless communications such as global positioning system (GPS), EDGE, GPRS, CDMA, WiMAX, LTE, EV-DO, or others. In some embodiments, a first communication chip 2312 may be dedicated to wireless communications, and a second communication chip 2312 may be dedicated to wired communications.

The computing device 2300 may include battery/power circuitry 2314. The battery/power circuitry 2314 may include one or more energy storage devices (e.g., batteries or capacitors) and/or circuitry for coupling components of the computing device 2300 to an energy source separate from the computing device 2300 (e.g., AC line power).

The computing device 2300 may include a display device 2306 (or corresponding interface circuitry, as discussed above). The display device 2306 may include any visual indicators, such as a heads-up display, a computer monitor, a projector, a touchscreen display, a liquid crystal display (LCD), a light-emitting diode display, or a flat panel display, for example.

The computing device 2300 may include an audio output device 2308 (or corresponding interface circuitry, as discussed above). The audio output device 2308 may include any device that generates an audible indicator, such as speakers, headsets, or earbuds, for example.

The computing device 2300 may include an audio input device 2318 (or corresponding interface circuitry, as discussed above). The audio input device 2318 may include any device that generates a signal representative of a sound, such as microphones, microphone arrays, or digital instruments (e.g., instruments having a musical instrument digital interface (MIDI) output).

The computing device 2300 may include a GPS device 2316 (or corresponding interface circuitry, as discussed above). The GPS device 2316 may be in communication with a satellite-based system and may receive a location of the computing device 2300, as known in the art.

The computing device 2300 may include another output device 2310 (or corresponding interface circuitry, as discussed above). Examples of the other output device 2310 may include an audio codec, a video codec, a printer, a wired or wireless transmitter for providing information to other devices, or an additional storage device.

The computing device 2300 may include another input device 2320 (or corresponding interface circuitry, as discussed above). Examples of the other input device 2320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2300 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2300 may be any other electronic device that processes data.

### Select Examples

The following paragraphs provide various examples of the embodiments disclosed herein.

Example 1 provides a method for accelerating deep learning, including storing, in a memory, an input tensor of a convolutional layer in a DNN, the input tensor including one or more channels, a channel including activations arranged in rows and columns; reading at least a portion of the input tensor from the memory into a datastore, the datastore including one or more databanks, a databank storing a group of activations in the channel; and providing a vector to a PE, the vector including one or more activations in the group, the PE including a multiplier that is to perform multiplication operations on the vector.

Example 2 provides the method of example 1, where the DNN further comprises one or more backend layers, the one or more backend layers comprise one or more other convolutional layers, and the convolutional layer is a frontend layer arranged before the one or more backend layers.

Example 3 provides the method of example 1 or 2, where the activations in the group are in one of the rows of the channel.

Example 4 provides the method of any of the preceding examples, where the convolutional layer has a kernel including weights arranged in rows and columns, and a number of activations in the vector equals a number of weights in a row of the kernel.

Example 5 provides the method of example 4, where the multiplier is to perform the multiplication operations on the vector and a weight vector, and the weight vector includes weights in one of the rows of the kernel.

Example 6 provides the method of example 4 or 5, where providing the vector to the PE includes reading a sequence of activations from the datastore into a storage unit of the PE, where a number of the activations in the sequence is larger than the number of the weights in the row of the kernel; and reading a bitmap from the datastore into the storage unit of the PE, where the bitmap includes a sequence of bits, a number of bits having values of one in the bitmap equals the number of the weights in the row of the kernel, and the bitmap is to be applied on the sequence of activations to extract the one or more activations from the group.

Example 7 provides the method of example 6, where the sequence of activations starts with a first activation and is read from the datastore at a first time, a different sequence of activation starts with a second activation and is read from the datastore at a second time that is different from the first time, and a position of the second activation in the input tensor is determined based on a position of the first activation in the input tensor and a stride size of the convolutional layer.

Example 8 provides the method of any of the preceding examples, where providing the vector to the PE includes reading a sequence of activations from the datastore; modifying the sequence of activations by adding one or more pad elements into the sequence to generate a new sequence of activations, the one or more pad elements having a predetermined value; writing the new sequence of activations into a storage unit of the PE; and transferring a bitmap from the datastore into the storage unit of the PE, where the bitmap includes a sequence of bits that includes one or more bits have a value of zero and one or more bits have a value of one, and the vector is generated based on the bitmap and the new sequence of activations.

Example 9 provides the method of example 8, where reading the sequence of activations from the datastore includes reading the sequence of activations from the datastore at a first time, the one or more pad elements includes two pad elements, the sequence of activations is read from the datastore at a second time that is later than the first time, and after the sequence of activations is read from the datastore at the second time, another new sequence of activations is generated by adding one pad element into the sequence of activations.

Example 10 provides the method of any of the preceding examples, where the vector is a first vector in the input tensor, the multiplier is a first multiplier in the PE, the method further includes transmitting a second vector from another databank of the datastore to the PE, a second multiplier of the PE is to perform multiplication operations on the second vector, and the first vector is in a different row of the input tensor from the second vector.

Example 11 provides the method of any of the preceding examples, where the vector is a first vector in the input tensor, the multiplier is to perform multiplication operations on the first vector at a first time, the multiplier is to perform multiplication operations on a second vector in the input tensor at a second time that is different from the first time, and the second vector includes one or more activations in the first vector.

Example 12 provides the method of example 11, where the multiplier is to perform multiplication operations on a third vector in the input tensor at a third time, the second time is after the first time and before the third time, and the third vector includes one or more activations in the first vector or in the second vector.

Example 13 provides the method of example 11 or 12, where transmitting the vector from the datastore to the PE includes reading another vector from the databank into a register file of the PE, where the another vector includes activations in the first vector and activations in the second vector, and the one or more activations in the first vector are determined based on a stride size of the convolutional layer.

Example 14 provides the method of any of the preceding examples, where the multiplier is a first multiplier of the PE, the vector is a first vector in the input tensor, the input tensor further includes a second vector and a third vector that have one or more different activations from the first vector, the first multiplier is to perform the multiplication operations on the first vector in a first operation round of the PE and is to perform multiplication operations on a second vector in a second operation round of the PE, and a second multiplier of the PE is to perform multiplication operations on a third vector in the first operation round and in the second operation round.

Example 15 provides the method of example 14, where the first multiplier is configured to perform multiplication operations on the second vector in a third operation round of the PE, and the second operation round is between the first operation round and the third operation round.

Example 16 provides a compute block for deep learning, including a memory configured to store an input tensor of a convolutional layer in a DNN, the input tensor including one or more channels, a channel including activations arranged in rows and columns; a datastore configured to store at least a portion of the input tensor from the memory, the datastore including one or more databanks, a databank storing a group of activations in the channel; and a PE array configured to receive a vector and to perform multiply-accumulate operations based on the vector, the vector including one or more activations in the group, the PE including a multiplier configured to perform multiplication operations on the vector.

Example 17 provides the compute block of example 16, where the DNN further comprises one or more backend layers, the one or more backend layers comprise one or more other convolutional layers, and the convolutional layer is a frontend layer arranged before the one or more backend layers.

Example 18 provides the compute block of example 16 or 17, where the convolutional layer has a kernel including weights arranged in rows and columns, a number of activations in the vector equals a number of weights in a row of the kernel, and the computer block further include a read module configured to read a sequence of activations from the datastore into a storage unit of the PE, where a number of the activations in the sequence is larger than the number of the weights in the row of the kernel, and read a bitmap from the datastore into the storage unit of the PE, where the bitmap includes a sequence of bits, a number of bits having values of one in the bitmap equals the number of the weights in the row of the kernel, and the bitmap is to be applied on the sequence of activations to extract the one or more activations from the group.

Example 19 provides the compute block of example 18, where the sequence of activations starts with a first activation and is read from the datastore at a first time, a different sequence of activation starts with a second activation and is read from the datastore at a second time that is different from the first time, and a position of the second activation in the input tensor is determined based on a position of the first activation in the input tensor and a stride size of the convolutional layer.

Example 20 provides the compute block of any one of examples 16-19, further including a padding module configured to receive a sequence of activations stored in the datastore; receive a bitmap stored in the datastore, the bitmap including a sequence of bits that includes one or more bits have a value of zero and one or more bits have a value of one; and modify the sequence of activations by adding one or more pad elements into the sequence to generate a new sequence of activations, the one or more pad elements having a predetermined value, where the vector is generated based on the bitmap and the new sequence of activations.

Example 21 provides a DNN accelerator, including an external memory; and a compute block, including a memory configured to store an input tensor of a convolutional layer in a DNN, the input tensor including one or more channels, a channel including activations arranged in rows and columns, a datastore configured to store at least a portion of the input tensor from the memory, the datastore including one or more databanks, a databank storing a group of activations in the channel, and a PE array configured to receive a vector and to perform multiply-accumulate operations based on the vector, the vector including one or more activations in the group, the PE including a multiplier configured to perform multiplication operations on the vector.

Example 22 provides the DNN accelerator of example 21, where the DNN further comprises one or more backend layers, the one or more backend layers comprise one or more other convolutional layers, and the convolutional layer is a frontend layer arranged before the one or more backend layers.

Example 23 provides the DNN accelerator of example 21 or 22, where the convolutional layer has a kernel including weights arranged in rows and columns, a number of activations in the vector equals a number of weights in a row of the kernel, and the computer block further include a read module configured to read a sequence of activations from the datastore into a storage unit of the PE, where a number of the activations in the sequence is larger than the number of the weights in the row of the kernel, and read a bitmap from the datastore into the storage unit of the PE, where the bitmap includes a sequence of bits, a number of bits having values of one in the bitmap equals the number of the weights in the row of the kernel, and the bitmap is to be applied on the sequence of activations to extract the one or more activations from the group.

Example 24 provides the DNN accelerator of any one of examples 21-23, where the compute block further includes a padding module configured to receive a sequence of activations stored in the datastore; receive a bitmap stored in the datastore, the bitmap including a sequence of bits that includes one or more bits have a value of zero and one or more bits have a value of one; and modify the sequence of activations by adding one or more pad elements into the sequence to generate a new sequence of activations, the one or more pad elements having a predetermined value, where the vector is generated based on the bitmap and the new sequence of activations.

Example 25 provides the DNN accelerator of any one of examples 21-24, where the external memory is a dynamic random-access memory, and the local memory is a static random-access memory.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for accelerating deep learning, comprising:
storing, in a memory, an input tensor of a convolutional layer in a deep neural network (DNN), the input tensor comprising one or more channels, a channel comprising activations arranged in rows and columns;
reading at least a portion of the input tensor from the memory into a datastore, the datastore comprising one or more databanks, a databank storing a group of activations in the channel; and
providing a vector to a processing element, the vector comprising one or more activations in the group, the processing element comprising a multiplier that is to perform multiplication operations on the vector.

2. The method of claim 1, wherein the DNN further comprises one or more backend layers, the one or more backend layers comprise one or more other convolutional layers, and the convolutional layer is a frontend layer arranged before the one or more backend layers.

3. The method of claim 1, wherein the activations in the group are in one of the rows of the channel.

4. The method of claim 1, wherein the convolutional layer has a kernel comprising weights arranged in rows and columns, and a number of activations in the vector equals a number of weights in a row of the kernel.

5. The method of claim 4, wherein the multiplier is to perform the multiplication operations on the vector and a weight vector, and the weight vector comprises weights in one of the rows of the kernel.

6. The method of claim 4, wherein providing the vector to the processing element comprises:
reading a sequence of activations from the datastore into a storage unit of the processing element, wherein a number of the activations in the sequence is larger than the number of the weights in the row of the kernel; and
reading a bitmap from the datastore into the storage unit of the processing element, wherein the bitmap comprises a sequence of bits, a number of bits having values of one in the bitmap equals the number of the weights in the row of the kernel, and the bitmap is to be applied on the sequence of activations to extract the one or more activations from the group.

7. The method of claim 6, wherein:
the sequence of activations starts with a first activation and is read from the datastore at a first time,
a different sequence of activation starts with a second activation and is read from the datastore at a second time that is different from the first time, and
a position of the second activation in the input tensor is determined based on a position of the first activation in the input tensor and a stride size of the convolutional layer.

8. The method of claim 1, wherein providing the vector to the processing element comprises:
reading a sequence of activations from the datastore;
modifying the sequence of activations by adding one or more pad elements into the sequence to generate a new sequence of activations, the one or more pad elements having a predetermined value;
writing the new sequence of activations into a storage unit of the processing element; and
transferring a bitmap from the datastore into the storage unit of the processing element, wherein the bitmap comprises a sequence of bits that includes one or more bits have a value of zero and one or more bits have a value of one, and the vector is generated based on the bitmap and the new sequence of activations.

9. The method of claim 8, wherein:
reading the sequence of activations from the datastore comprises reading the sequence of activations from the datastore at a first time,
the one or more pad elements comprises two pad elements,
the sequence of activations is read from the datastore at a second time that is later than the first time, and
after the sequence of activations is read from the datastore at the second time, another new sequence of activations is generated by adding one pad element into the sequence of activations.

10. The method of claim 1, wherein:
the vector is a first vector in the input tensor,
the multiplier is a first multiplier in the processing element,
the method further comprises transmitting a second vector from another databank of the datastore to the processing element,
a second multiplier of the processing element is to perform multiplication operations on the second vector, and
the first vector is in a different row of the input tensor from the second vector.

11. The method of claim 1, wherein:
the vector is a first vector in the input tensor,
the multiplier is to perform multiplication operations on the first vector at a first time,
the multiplier is to perform multiplication operations on a second vector in the input tensor at a second time that is different from the first time, and
the second vector comprises one or more activations in the first vector.

12. The method of claim 11, wherein:
the multiplier is to perform multiplication operations on a third vector in the input tensor at a third time,
the second time is after the first time and before the third time, and
the third vector comprises one or more activations in the first vector or in the second vector.

13. The method of claim 11, wherein transmitting the vector from the datastore to the processing element comprises:
reading another vector from the databank into a register file of the processing element,
wherein the another vector comprises activations in the first vector and activations in the second vector, and the one or more activations in the first vector are determined based on a stride size of the convolutional layer.

14. The method of claim 1, wherein:
the multiplier is a first multiplier of the processing element,
the vector is a first vector in the input tensor,
the input tensor further comprises a second vector and a third vector that have one or more different activations from the first vector,
the first multiplier is to perform the multiplication operations on the first vector in a first operation round of the processing element and is to perform multiplication operations on a second vector in a second operation round of the processing element, and
a second multiplier of the processing element is to perform multiplication operations on a third vector in the first operation round and in the second operation round.

15. The method of claim 14, wherein:
the first multiplier is configured to perform multiplication operations on the second vector in a third operation round of the processing element, and
the second operation round is between the first operation round and the third operation round.

16. A compute block for deep learning, comprising:
a memory configured to store an input tensor of a convolutional layer in a deep neural network (DNN), the input tensor comprising one or more channels, a channel comprising activations arranged in rows and columns;
a datastore configured to store at least a portion of the input tensor from the memory, the datastore comprising one or more databanks, a databank storing a group of activations in the channel; and
a processing element array configured to receive a vector and to perform multiply-accumulate operations based on the vector, the vector comprising one or more activations in the group, the processing element comprising a multiplier configured to perform multiplication operations on the vector.

17. The compute block of claim 16, wherein the DNN further comprises one or more backend layers, the one or more backend layers comprise one or more other convolutional layers, and the convolutional layer is a frontend layer arranged before the one or more backend layers.

18. The compute block of claim 16, wherein the convolutional layer has a kernel comprising weights arranged in rows and columns, a number of activations in the vector equals a number of weights in a row of the kernel, and the computer block further comprise a read module configured to:
read a sequence of activations from the datastore into a storage unit of the processing element, wherein a number of the activations in the sequence is larger than the number of the weights in the row of the kernel, and
read a bitmap from the datastore into the storage unit of the processing element, wherein the bitmap comprises a sequence of bits, a number of bits having values of one in the bitmap equals the number of the weights in the row of the kernel, and the bitmap is to be applied on the sequence of activations to extract the one or more activations from the group.

19. The compute block of claim 18, wherein:
the sequence of activations starts with a first activation and is read from the datastore at a first time,
a different sequence of activation starts with a second activation and is read from the datastore at a second time that is different from the first time, and
a position of the second activation in the input tensor is determined based on a position of the first activation in the input tensor and a stride size of the convolutional layer.

20. The compute block of claim 16, further comprising a padding module configured to:
receive a sequence of activations stored in the datastore;
receive a bitmap stored in the datastore, the bitmap comprising a sequence of bits that includes one or more bits have a value of zero and one or more bits have a value of one; and
modify the sequence of activations by adding one or more pad elements into the sequence to generate a new sequence of activations, the one or more pad elements having a predetermined value,
wherein the vector is generated based on the bitmap and the new sequence of activations.

21. A deep neural network (DNN) accelerator, comprising:
an external memory; and
a compute block, comprising:
a local memory configured to store an input tensor of a convolutional layer in a DNN, the input tensor comprising one or more channels, a channel comprising activations arranged in rows and columns,
a datastore configured to store at least a portion of the input tensor from the local memory, the datastore comprising one or more databanks, a databank storing a group of activations in the channel, and
a processing element array configured to receive a vector and to perform multiply-accumulate operations based on the vector, the vector comprising one or more activations in the group, the processing element comprising a multiplier configured to perform multiplication operations on the vector.

22. The DNN accelerator of claim 21, wherein the DNN further comprises one or more backend layers, the one or more backend layers comprise one or more other convolutional layers, and the convolutional layer is a frontend layer arranged before the one or more backend layers.

23. The DNN accelerator of claim 21, wherein the convolutional layer has a kernel comprising weights arranged in rows and columns, a number of activations in the vector equals a number of weights in a row of the kernel, and the computer block further comprise a read module configured to:
read a sequence of activations from the datastore into a storage unit of the processing element, wherein a number of the activations in the sequence is larger than the number of the weights in the row of the kernel, and
read a bitmap from the datastore into the storage unit of the processing element,
wherein the bitmap comprises a sequence of bits, a number of bits having values of one in the bitmap equals the number of the weights in the row of the kernel, and the bitmap is to be applied on the sequence of activations to extract the one or more activations from the group.

24. The DNN accelerator of claim 21, wherein the compute block further comprises a padding module configured to:
receive a sequence of activations stored in the datastore;
receive a bitmap stored in the datastore, the bitmap comprising a sequence of bits that includes one or more bits have a value of zero and one or more bits have a value of one; and
modify the sequence of activations by adding one or more pad elements into the sequence to generate a new sequence of activations, the one or more pad elements having a predetermined value,
wherein the vector is generated based on the bitmap and the new sequence of activations.

25. The DNN accelerator of claim 21, wherein the external memory is a dynamic random-access memory, and the local memory is a static random-access memory.
